(19) United States
(12) Patent Application Publication
(10) Pub. No.: US 2023/0300739 A1
(43) Pub. Date: Sep. 21, 2023

(54) RACH PROCEDURES FOR REQUESTING SLICE SUPPORT INFORMATION

(71) Applicant: Google LLC, Mountain View, CA (US)

(72) Inventors: Pavan Nuggehalli, Mountain View, CA (US); Jibing Wang, Mountain View, CA (US); Shiangrung Ye, Mountain View, CA (US)

(21) Appl. No.: 18/040,772

(22) PCT Filed: Aug. 4, 2021
(86) PCT No.: PCT/US2021/044480

§ 371 Date: Feb. 6, 2023

Related U.S. Application Data
(60) Provisional application No. 63/061,631, filed on Aug. 5, 2020.
(60) Provisional application No. 63/061,619, filed on Aug. 5, 2020.

(51) Int. Cl. H04W 48/20; H04W 48/16

(52) U.S. Cl. CPC H04W 48/20; H04W 48/16; H04W 74/0833

(57) ABSTRACT

In a method in a base station configured to communicate with a user device located in a coverage area of a cell associated with the base station, a first random access message of a RACH procedure is received (320, 420A, 420B, or 520) from the user device. The method also includes determining (425A, 426B, or 526), by processing hardware of the base station, that the first random access message is associated with a first network slice, at least in part by determining that the user device transmitted the first random access message using a RACH configuration associated with the first network slice. The method also includes transmitting (330, 430A, 430B, 530) to the user device a second random access message of the RACH procedure. The second random access message includes information regarding network support for the first network slice.

### FIELD OF THE DISCLOSURE

This disclosure relates generally to wireless communications and, more particularly, to radio access networks and network slicing.

### BACKGROUND

As increases in connectivity and mobility enable transformation and innovation in numerous sectors (e.g., manufacturing, transportation, energy, civil services, healthcare, etc.), there is a corresponding increase of demand for wireless communications in vertical markets. The applications/services in these vertical markets can have widely varying performance requirements with respect to parameters such as throughput, capacity, latency, mobility, reliability, and so on. Network slicing (e.g., as provided in 5G networks under 3GPP Release 15) can provide a flexible and scalable network architecture to support these disparate requirements, by overlaying logical networks with differentiated services on the same physical network. To date, however, efforts to support network slicing have focused almost exclusively on the core network (CN), with relatively little attention given to the radio access network (RAN). As a result, opportunities exist to improve network performance by incorporating slice-based functionality in the RAN.

### SUMMARY

A base station of this disclosure can inform a user equipment (UE) as to which network slice or network slices (also referred to herein as simply “slice(s)”) is/are supported by a cell of the base station, thereby allowing the UE to make faster decisions regarding network connectivity (e.g., whether to select the cell or, if the cell is already a serving cell, whether to reselect to a different cell). In the implementations and scenarios discussed herein, each slice may correspond to a network slice selection assistance information (NSSAI), or to a “single NSSAI” (S-NSSAI) within an NSSAI, for example. The base station can broadcast the slice information in a system information block (SIB) such as a SIB1, or transmit the slice information in a radio resource control (RRC) message during an RRC reconfiguration, establishment, reestablishment, or connection resume procedure, for example. In some implementations, the base station provides the slice information as a bitmap, with each bit corresponding to a different network slice.

In some implementations the UE can request, on demand, that a base station provide information about network support for a particular slice of interest to the UE. For example, the UE may request such information when the UE is ready to (or expects that it may soon) transmit uplink data associated with the slice, but the serving cell does not support that slice (or, in some implementations/scenarios, when the UE is ready to transmit the uplink data and the serving cell chose not to broadcast system information regarding which slice(s) the cell supports). The base station may respond, for example, by indicating a radio access technology (RAT), frequency, or neighboring cell identifier that supports the particular slice, and/or may provide other information that can expedite a change in UE network connectivity that might facilitate support for the slice (e.g., a random access channel (RACH) configuration that the UE can use in a neighboring cell that supports the slice, etc.).

The UE may request the network support information by sending the base station a random access message of a RACH procedure (e.g., a MsgA of a two-step, contention-based RACH procedure or a Msg1 of a four-step, contention-based RACH procedure) using a RACH configuration (e.g., preamble and/or PRACH occasion) that is specifically associated with the network slice of interest. Prior to the request, the base station may provide a number of dedicated, slice-specific RACH configurations to the UE (e.g., in a SIB or dedicated RRC message), such that the UE can identify and use the appropriate RACH configuration when requesting network support information for a given slice. Upon receiving the random access message, the base station can determine/identify the slice based on which RACH configuration (e.g., which preamble and/or PRACH occasion) the UE used to send the random access message. The base station can then include the requested network support information for the slice in a responsive random access message (e.g., a modified Msg2 or MsgB), for example. In some implementations and/or scenarios, the UE uses dedicated, slice-specific RACH configurations solely to request network support information for one or more slices, without attempting to gain access to a channel of the current cell via the RACH procedure. For example, the UE may remain in an idle or inactive state regardless of channel availability on the current cell, and the RACH procedure may therefore be abbreviated. Accordingly, as used herein, the term “RACH procedure” can refer to a full RACH procedure (e.g., substantially as specified in a standard for the current RAT), or can refer to only a portion of such a procedure (e.g., with no corresponding HARQ processing at the base station), and does not necessarily require that the procedure (or message, etc.) be used in an attempt to gain channel access.

In some implementations, the RAN uses offsets to steer UEs towards or away from particular cells based on whether those cells support network slices that the UEs need (or prefer, expect, etc.) to make use of. To this end, a base station can transmit offsets for use in cell selection and/or offsets for use in cell reselection. For cell selection, each base station may broadcast its own positive and/or negative offset(s), which in-range UEs can then use when calculating values for cell suitability (e.g., by modifying the S-criteria as defined in TS 38.304). For example, a UE may apply a positive offset (or no offset) for a first cell that supports at least one network slice of interest to the UE, and no offset (or a negative offset) for a second cell that does not support any network slice of interest to the UE.

For cell reselection, the serving base station may transmit the offset(s) for its own (serving) cell, as well an indication of “favored” neighboring cells that support the same network slice(s) or a subset of the network slices(s) as the serving cell. The UE can then use this information, along with knowledge of its own slice needs/preferences, to positively and/or negatively offset ranks for the serving cell and neighboring cells (e.g., by modifying Rₛ and Rₙ as defined in TS 38.304).

Whether used for cell selection and/or cell reselection, offsets may be slice-specific (e.g., a different offset for each slice) or more generally applicable (e.g., a single offset that a UE applies, or does not apply, based on whether a cell supports at least one desired slice). In implementations where offsets are slice-specific, and in scenarios where the UE wants support for multiple slices, the UE can use various techniques to determine cell suitability or cell rank (e.g., summing all offsets associated with the desired network slices, or using a maximum or minimum of those offsets, etc.).

One example embodiment of these techniques is a method, in a base station configured to communicate with a user device located in a coverage area of a cell associated with the base station, that includes receiving from the user device a first random access message of a random access channel, RACH, procedure, determining, by processing hardware of the base station, that the first random access message is associated with a first network slice, and transmitting to the user device a second random access message of the RACH procedure, the second random access message including information regarding network support for the first network slice.

Another example embodiment of these techniques is a method, in a user device configured to communicate with a base station when located in a coverage area of a cell associated with the base station, that includes identifying, by processing hardware of the user device, a desired network slice, transmitting a first random access message of a first random access channel, RACH, procedure to the base station using a first RACH configuration associated with the desired network slice, receiving a second random access message of the first RACH procedure in response to the first random access message, and identifying, by the processing hardware and based on the second random access message, network support for the desired network slice.

### BRIEF DESCRIPTION OF THE DRAWINGS

FIG. 1 illustrates an example wireless communication system in which UEs and base stations can implement the techniques of this disclosure to provide RAN support for network slicing;

FIG. 2 is a block diagram of an example protocol stack according to which the UE of FIG. 1 communicates with one or more base stations of FIG. 1;

FIG. 3 is a messaging diagram of an example scenario in which a base station provides a UE with information regarding which slice(s) the base station supports, after which the UE requests network support information for an unsupported slice;

FIGS. 4A and 4B are messaging diagrams of example procedures in which a UE uses a four-step, contention-based RACH procedure to request network support information for a particular slice;

FIG. 5 is a messaging diagram of an example procedure in which a UE uses a two-step, contention-based RACH procedure to request network support information for a particular slice;

FIGS. 6-8 are messaging diagrams of example scenarios in which a UE has data associated with multiple slices ready for uplink transmission;

FIG. 9 is a messaging diagram of an example scenario in which base stations provide a UE with offsets to steer the UE towards or away from the cells associated with the base stations during cell selection;

FIG. 10 is a messaging diagram of an example scenario in which a serving base station provides a UE with one or more offsets to steer the UE towards or away from the serving cell and/or neighboring cells during cell reselection;

FIGS. 11 and 12 are flow diagrams of example methods for informing a user device of which slice(s) is/are supported by a base station, from the perspective of the base station and the user device, respectively; and

FIGS. 13 and 14 are flow diagrams of example methods for using a RACH procedure to obtain network support information for a slice, from the perspective of the base station and the user device, respectively.

### DETAILED DESCRIPTION OF THE DRAWINGS

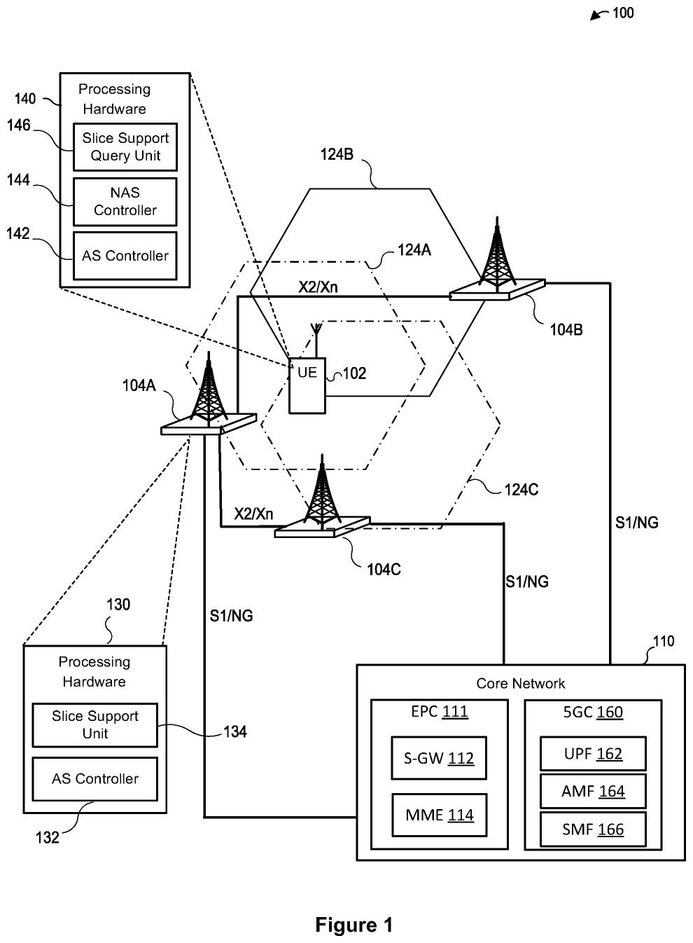

FIG. 1 depicts an example wireless communication system 100 in which a UE 102 is configured to communicate with base stations 104A, 104B, and 104C (collectively referred to herein as “base stations 104”) at different times or, in some scenarios and implementations that support dual connectivity or carrier aggregation, simultaneously. The UE 102 can be any suitable device capable of wireless communication with base stations 104 (e.g., any of the exemplary user devices discussed below after the description of the figures). The base stations 104 can include any suitable type, or types, of base stations, such as an evolved node B (eNB), a next-generation eNB (ng-eNB), and/or a 5G Node B (gNB), for example. In the example shown in FIG. 1, each of the base stations 104 is connected to a core network (CN) 110.

As a more specific example, the base station 104A may be an eNB supporting an S1 interface for communicating with an EPC 110 of CN 110, and the base stations 104B and 104C may be gNBs each supporting an NG interface for communicating with a 5GC 112 of CN 110. In other implementations and/or scenarios, the base stations 104A, 104B, and/or 104C can instead (or also) operate according to radio access technologies (RATs) of other types, and/or the base stations 104A, 104B, and/or 104C can instead (or also) be connected to CNs of other types. For example, the base station 104A may operate as an ng-eNB and/or the base station 104B may operate as an en-gNB. In different implementations, the base stations 104A, 104B, and/or 104C implement the same RAT or different RATs, and support the same or different frequency bands. To directly exchange messages with each other during the various implementations and scenarios discussed below, the base stations 104 may support Xn and/or X2 interfaces, as shown in FIG. 1.

Among other components, the EPC 111 can include a Serving Gateway (S-GW) 112 and a Mobility Management Entity (MME) 114. The S-GW 112 is generally configured to transfer user-plane packets related to audio calls, video calls, Internet traffic, etc., and the MME 114 is generally configured to manage authentication, registration, paging, and other related functions. The 5GC 160 includes a User Plane Function (UPF) 162 and an Access and Mobility Management Function (AMF) 164, and/or a Session Management Function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

Generally, the wireless communication system 100 may include any suitable number of base stations supporting NR cells or EUTRA cells. More particularly, the CN 110 can be connected to any suitable number of base stations supporting NR cells and/or EUTRA cells. Although the examples herein refer primarily to the specific CN types EPC and 5GC, and the specific RAT types EUTRA and 5G NR, in general the techniques of this disclosure can also apply to other suitable radio access and/or core network technologies, such as sixth generation (6G) radio access and/or 6G core network, for example.

In the example implementation of FIG. 1, the base station 104A covers a cell 124A, the base station 104B covers a cell 124B, and the base station 104C covers a cell 124C. In the cells 124, the UE 102 can use a RACH procedure to gain access to an uplink channel for communicating with the respective one of the base stations 104. The UE 102 and the base station 104A, for example, can support one or more types of RACH procedures. In one implementation, the UE 102 and the base station 104A support only a contention-based four-step RACH procedure. In another implementation (e.g., if the base station 104A supports a 5G NR RAT), the UE 102 and the base station 104A may support a contention-based four-step RACH procedure, a contention-based two-step RACH procedure, and a “fallback” procedure for changing from a two-step to a four-step RACH procedure. In the cell 124A, other UEs (not shown in FIG. 1) can also operate and, at times, attempt to gain access to the same uplink channel (e.g., the same time-frequency resource for uplink transmissions) as the UE 102. The other UEs may be similar to the UE 102, or may be other types of devices that are similarly able to communicate with the base station 104A via the cell 124A using the same RACH procedure(s) as the UE 102.

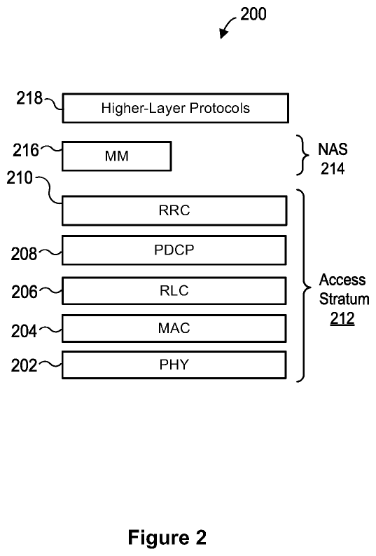

As illustrated in FIG. 1, the base station 104A is equipped with processing hardware 130, which can include one or more general-purpose processors (e.g., central processing units (CPUs)) and non-transitory computer-readable memory storing machine-readable instructions that are executable on the one or more general-purpose processors, and/or special-purpose processing units. The processing hardware 130 includes an access stratum (AS) controller 132 and a slice support unit 134. The AS controller 132 generally supports procedures at AS layers, such as the AS layers discussed below in connection with FIG. 2 (e.g., PHY, RRC, MAC, etc.). For example, the AS controller 132 may control RACH procedures for the base station 104, RRC messaging, and so on. The AS controller 132 may be a single controller, include a number of different controllers (e.g., a RACH controller, RRC controller, PHY controller, etc.), or be a part of another controller.

With respect to RACH procedures, the AS controller 132 can configure UEs (e.g., UE 102) with a set of available time-frequency resources (e.g., PRACH occasions), from which the UEs can select a specific time-frequency resource to transmit a first message of the RACH procedure (e.g., a MsgA or Msg1). The AS controller 132 may also, or instead, configure UEs with a set of preambles each associated with a different PRACH occasion, where any UE using a particular PRACH occasion for a RACH procedure includes the corresponding preamble in the first RACH message (e.g., a MsgA or Msg1). In one such implementation, the AS controller 132 can also associate each preamble/PRACH occasion to a different PUSCH occasion (i.e., time-frequency resource for uplink data transmission), or possibly to a different set of multiple PUSCH occasions, and a UE using a particular preamble and PRACH occasion uses the corresponding PUSCH occasion (or one occasion from the corresponding set of PUSCH occasions) to transmit or re-transmit data (e.g., in a MsgA or Msg3). Each set of time-frequency resources, with its associated preamble (and possibly other information, such as how many times to send the preamble per attempt, etc.), constitutes a single RACH configuration.

In some implementations, the AS controller 132 can also configure UEs with RACH resources that are dedicated/reserved for purposes other than, or in addition to, channel access. In particular, and as discussed in further detail below, the AS controller 132 can configure UEs with specific RACH configurations that are dedicated for requesting network support information for particular slices (e.g., a first RACH configuration for requesting information about a first slice, a second RACH configuration for requesting information about a second slice, etc.). While the examples provided herein refer to requests for information about a particular slice (singular), it is understood that such requests may pertain to one or more additional slices as well (e.g., with a first RACH configuration being reserved for requesting information about a set of two specific slices, a second RACH configuration being reserved for requesting information about a set of five other slices, etc.).

The slice support unit 134 generally determines the slice-specific network support information requested by UEs, possibly by receiving some or all of the information from other base stations (e.g., from base stations 104B and 104C via X2 or Xn interfaces). The slice support unit 134 may be implemented by the AS controller 132, and/or another controller of the processing hardware 130. The slice support unit 134 may determine slice support information upon request from the UEs, periodically, and/or according to some other suitable timing.

The base stations 104B and 104C are equipped with processing hardware that may be similar to the processing hardware 130, but may differ in some respects (e.g., if supporting a different RAT, and possibly by excluding the slice support unit 134, etc.).

The UE 102 is equipped with processing hardware 140, which can include one or more general-purpose processors (e.g., CPUs) and non-transitory computer-readable memory storing machine-readable instructions that are executable on the one or more general-purpose processors, and/or special-purpose processing units. The processing hardware 140 includes an AS controller 142, a non-access stratum (NAS) controller 144, and a slice support query unit 146.

The AS controller 142 generally supports procedures at AS layers, such as the AS layers discussed below in connection with FIG. 2 (e.g., PHY, RRC, MAC, etc.). The AS controller 142 may be a single controller, include a number of different controllers (e.g., a RACH controller, RRC controller, PHY controller, etc.), or be a part of another controller. The AS controller 142 may control RACH procedures for the UE 102, cell selection and reselection procedures, and so on.

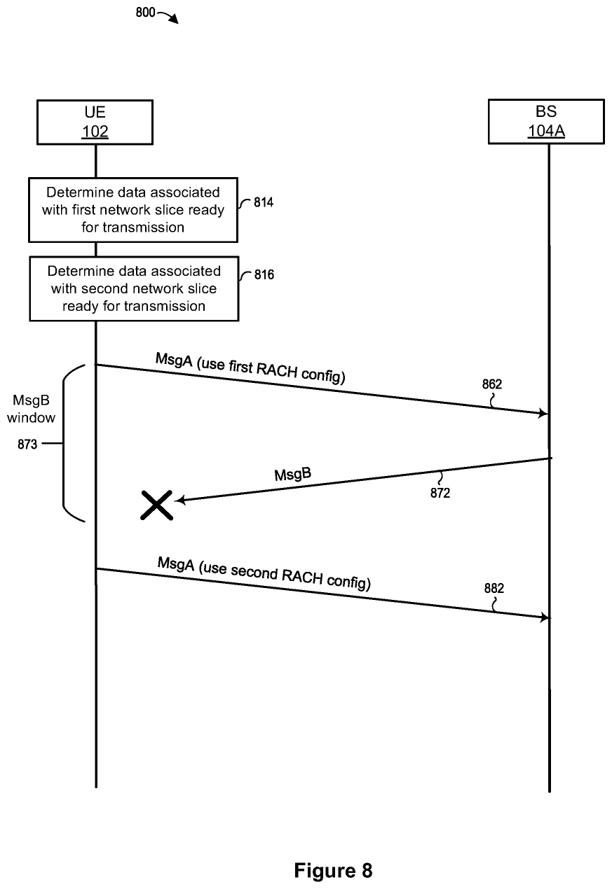

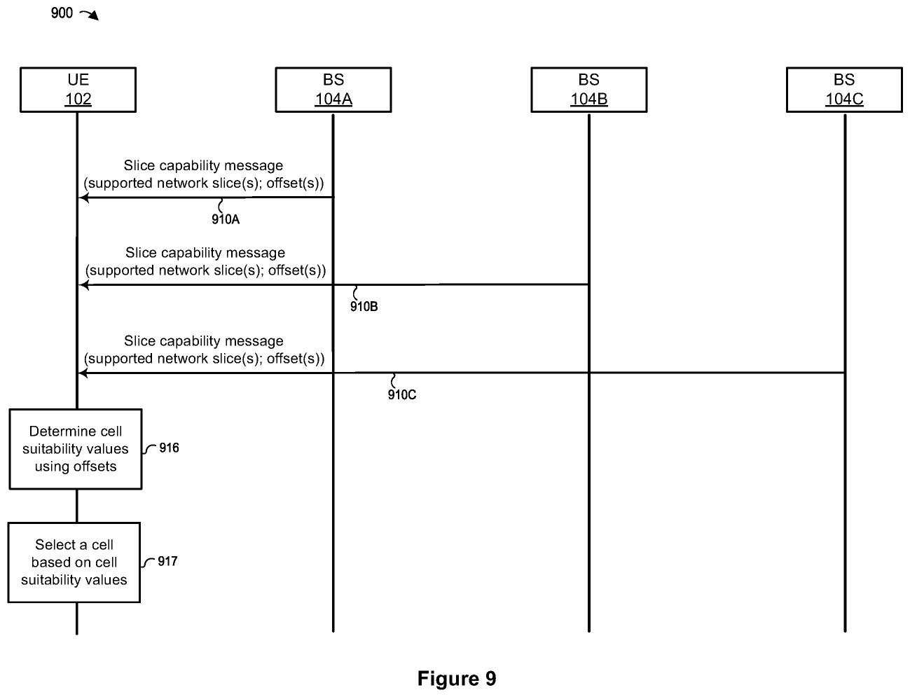

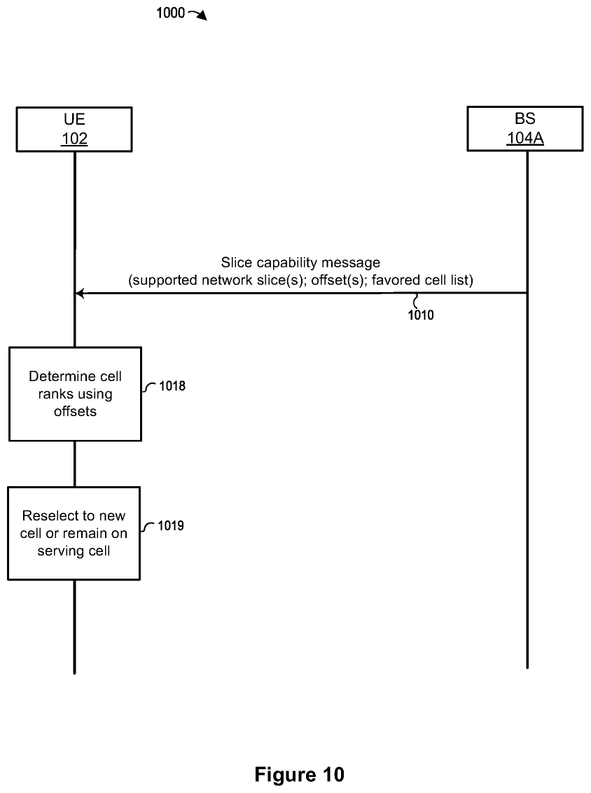

The AS controller 142 may perform cell selection and reselection substantially as defined in 3GPP TS 38.304. For cell selection, the AS controller 142 may consider a cell “suitable” if the cell is part of a selected public land mobile network (PLMN) or of a registered PLMN (or a PLMN of the equivalent PLMN list, etc.) and if cell suitability criteria are satisfied, with the cell suitability criteria relating to various cell measurements (e.g., signal power and signal quality). For cell reselection, the AS controller 142 may rank the serving cell and the neighboring cells based on similar cell measurements. In some implementations, however, when assessing cell suitability criteria for cell selection and/or when ranking cells for cell reselection, the AS controller 142 also applies offsets for particular cells based on the level of support for one or more slices of interest to the UE 102. Offsets of this sort are discussed in further detail below with reference to FIGS. 9 and 10.

The 3GPP NR specification supports the configuration of dedicated priorities for use in cell reselection, with each of the priorities corresponding to a different NR and/or inter-RAT frequency. In some implementations, however, the network (e.g., base station 104A) can configure UEs such as UE 102 with a specific set of such frequency priorities (from among multiple potential/candidate sets) based at least in part on slice information. For example, the UE 102 may be pre-configured with (store) a set of indices, with each index corresponding to a different set of frequency priorities. A base station (e.g., base station 104A) may then broadcast a particular index, and the UE 102 may apply the set of priorities that corresponds to that index. The base station may choose which index to broadcast based on the slice(s) that the base station supports, for example.

Alternatively, the UE 102 may be pre-configured with (e.g., store) a set of geographic tag values, with each value corresponding to a different set of frequency priorities. The geographic tag may be a tracking area code (TAC), a RAN area code, a list of cells, or local area data network (LADN) information, for example. A base station (e.g., base station 104A) may broadcast a particular tag value (e.g., a specific TAC, a specific RAN area code, etc.), and the UE 102 may apply the set of frequency priorities that corresponds to that tag value. The base station may choose which tag value to broadcast based on the slice(s) that the base station supports, for example.

In either case (index-based or tag-based sets of frequency priorities), the UE 102 can use the indicated set of frequency priorities during cell reselection. For example, the UE 102 may be more likely to reselect to a cell that supports a high-priority frequency, according to the set of frequency priorities indicated by the index or geographic tag value, as specified in the current specification (3GPP TS 38.304).

The NAS controller 144 generally supports procedures at NAS layers, such as mobility management procedures. The NAS controller 144 may be a single controller, include a number of different controllers, or be a part of another controller (e.g., another controller that also includes the AS controller 142). The NAS controller 144 can communicate with the AS controller 142 via inter-protocol layer (IPL) messages. In some implementations, the NAS controller 144 uses IPL messages to inform the AS controller 142 of which slices the UE 102 needs or prefers, after one or more higher (application) layers inform the NAS controller 144 of the slice needs/preferences. The NAS controller 144 may provide this information specifically for purposes of cell selection or cell reselection, for example. The NAS controller 144 may also inform the AS controller 142 of priorities associated with some or all of the desired slices, and/or provide an indication of whether each slice is an essential or non-essential slice.

In different implementations and/or scenarios, each desired slice (e.g., each NSSAI) may correspond to a particular PDU session (e.g., an operator-defined PDU session, an always-on PDU session, a PDU session with pending data, etc.), to a “requested” NSSAI (e.g., as defined in 3GPP specification TS 23.501), URSP (UE Route Selection Policy) configured by the (home) network, or to a local configuration (e.g., user configuration or OEM configuration) of the UE 102, for example. Generally, slices of interest may be locally determined by the UE 102 (e.g., based on which applications are running at the UE 102), and/or may be configured by the network (e.g., via NAS messages received by the UE 102 and NAS controller 144).

The network can also control, at least to some extent, how the UE 102 uses desired slice information. For example, the AMF 164 may send the UE 102 a NAS message indicating whether the UE 102 is permitted to perform cell selection and/or reselection for purposes of obtaining network support for a particular slice. Based on this NAS message, the NAS controller 144 may then include (or omit) a particular slice of interest from the list that the NAS controller 144 sends to the AS controller 142. For example, the NAS controller 144 may omit a desired slice from the list if the AMF 164 (or other network node) had informed the UE 102 that the UE 102 is not permitted to perform cell selection or reselection based on that slice. The AMF 164 (or another network node) may also configure the UE 102 with other restrictions on how NAS layers (i.e., the NAS controller 144) share slices of interest with lower layers (i.e., with the AS controller 142). For example, the AMF 164 may instruct the NAS controller 144 to share all desired NSSAI with the AS controller 142, to only share the highest-priority S-NSSAI of a desired NSSAI with the AS controller 142, or to not share any desired NSSAI with the AS controller 142, etc. In some implementations and/or scenarios, the NAS controller 144 also, or instead, determines the sharing and use of desired slice information based on pre-configurations (e.g., user and/or OEM configurations) at the UE 102.

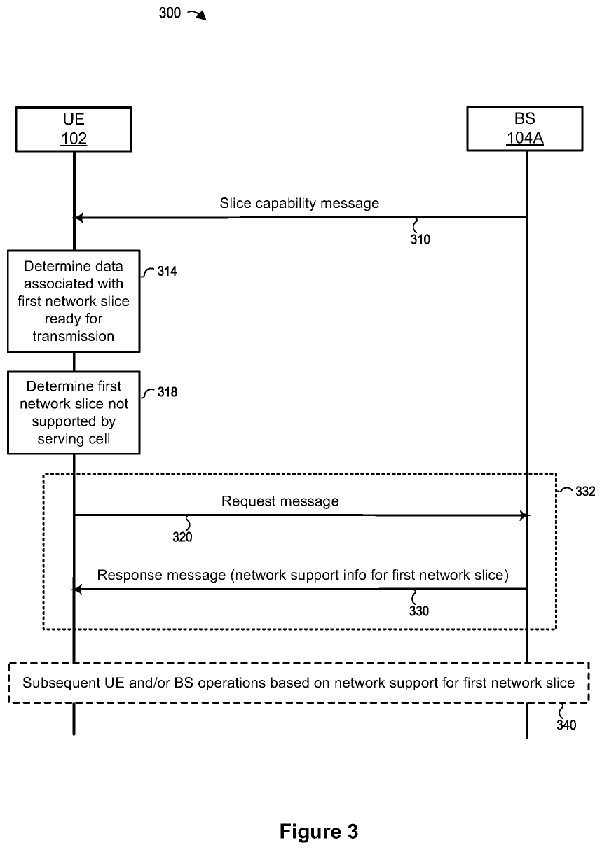

The slice support query unit 146 may be implemented by the AS controller 142, and/or by another controller of the UE 102. In general, the slice support query unit 146 executes one or more procedures for requesting slice-specific network support information from base stations (e.g., base station 104A). In some implementations, the slice support query unit 146 first identifies the slice(s) for which network support information is desired. In implementations where the slice support query unit 146 is executed by the AS controller 142, for example, and after the NAS controller 144 provides the AS controller 142 a list of desired slices, the slice support query unit 146 may compare that list to slice support information that the UE 102 received from a base station (e.g., base station 104A). If the overlap of desired slices and supported slices does not satisfy particular criteria (e.g., the serving base station supporting at least one desired slice, or all desired slices, or all desired slices that have at least a threshold priority level, etc.), then the slice support query unit 146 initiates a slice support query procedure. As discussed below in connection with FIGS. 3-5, the query procedure may be a RACH procedure that uses a RACH configuration (i.e., a specific set of RACH resources, such as a preamble and PRACH occasion) that is dedicated/reserved for making such queries, or may be another type of procedure (e.g., the UE 102 transmitting an RRC message that explicitly identifies the slice for which network support information is requested).

In some implementations, the UE 102 can transmit its list of desired slices (possibly with priority values) to a serving base station. For example, the UE 102 can include such a list in an RRCConfigurationComplete message that the UE 102 transmits to the base station 104A. The base station 104A can then use this desired slice information to locate better network support for one or more of the slices, and possibly to initiate a change in network connectivity for the UE 102. For example, the base station 104A may determine that it does not support one, some, or all slices of interest to the UE 102, and in response (1) determine a neighboring cell (and/or another RAT) that does support the slice(s), and (2) perform a handover to the neighboring cell (e.g., cell 124B or 124C) or otherwise redirect the UE 102 to the neighboring cell (and/or to the other RAT).

FIG. 2 illustrates, in a simplified manner, an example radio protocol stack 200 according to which the UE 102 may communicate with the base station 104A (and possibly also base stations 104B and 104C). In the example stack 200, a physical layer (PHY) 202 provides transport channels to a medium access control (MAC) layer 204, which in turn provides logical channels to a radio link control (RLC) layer 206. The RLC layer 206 in turn provides RLC channels to a packet data convergence protocol (PDCP) layer 208, which in turn communicates with an RRC layer 210. The RRC layer 210 packages and interprets RRC protocol data units (PDUs), which may contain any of various types of RRC messages associated with different RRC procedures (e.g., connection establishment or reestablishment procedures, a measurement reporting procedure, etc.). The layers 202 through 210 form at least a portion of an access stratum (AS) 212.

A non-access stratum (NAS) 214 of the protocol stack 200 includes, among other possible layers, one or more mobility management (MM) layers 216 for handling registration, attachment, or tracking area update procedures. As further illustrated in FIG. 2, the protocol stack 200 also supports higher-layer protocols 218 for various services and applications. For example, the higher-layer protocols 218 may include Internet Protocol (IP), Transmission Control Protocol and User Datagram Protocol (UDP).

In some implementations, the AS controllers 132 and 142 of FIG. 1 implement procedures of the AS 212, while the NAS controller 144 of FIG. 1 implements procedures of the NAS 214. While FIG. 2 depicts a specific ordering of the various layers 202, 204, 206, 208, 210, 216, and 218, it is understood that, in some implementations and/or scenarios, one or more of the depicted layers may operate in a manner that does not strictly conform to the ordering shown. Moreover, the UE 102 and base station(s) (e.g., base station 104A) may instead operate according to a different protocol stack in other implementations.

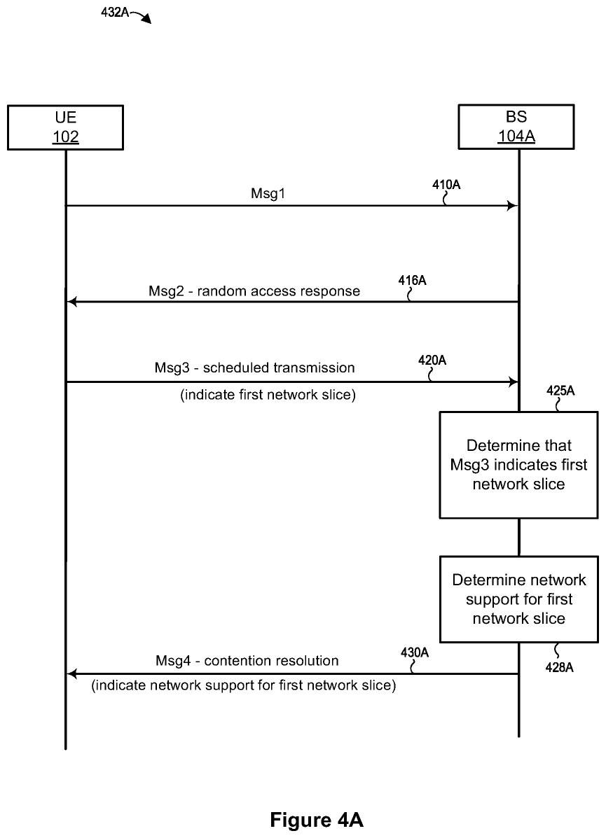

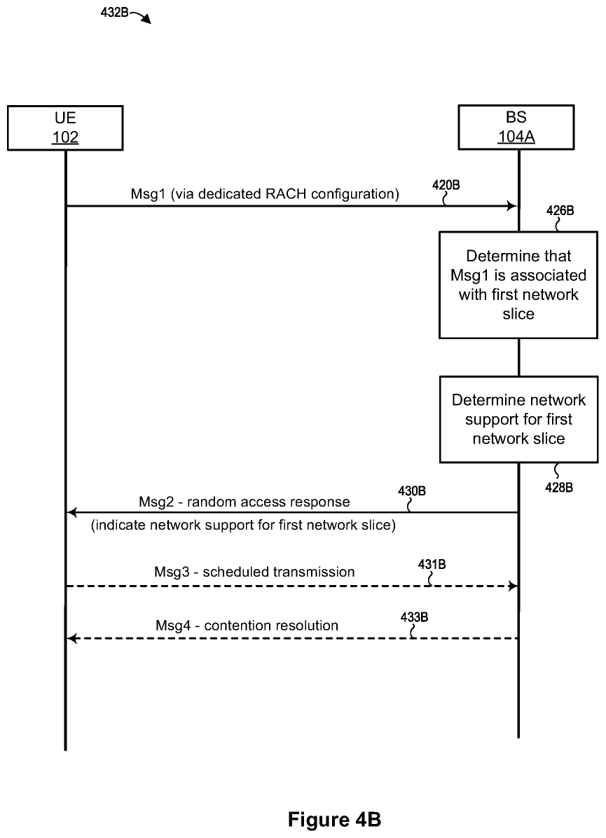

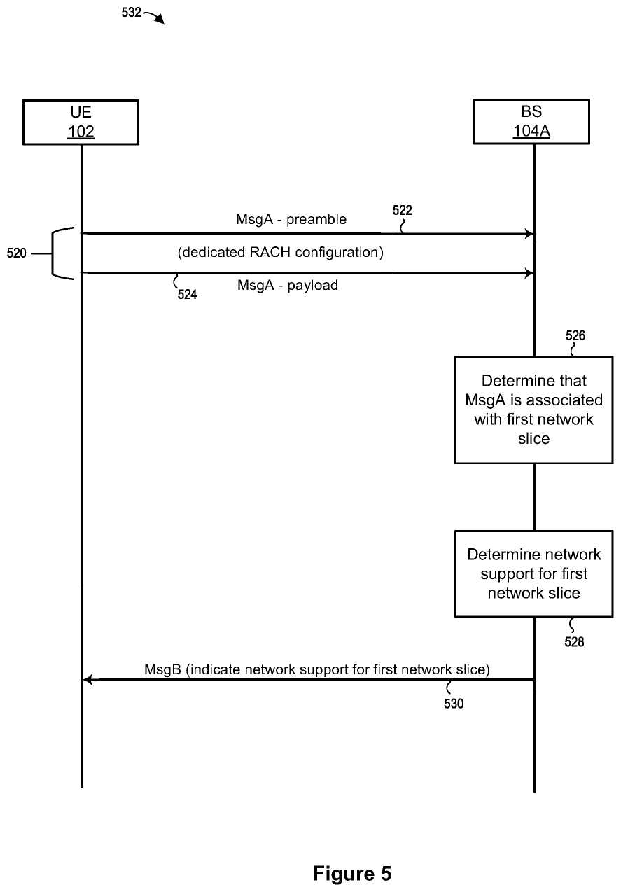

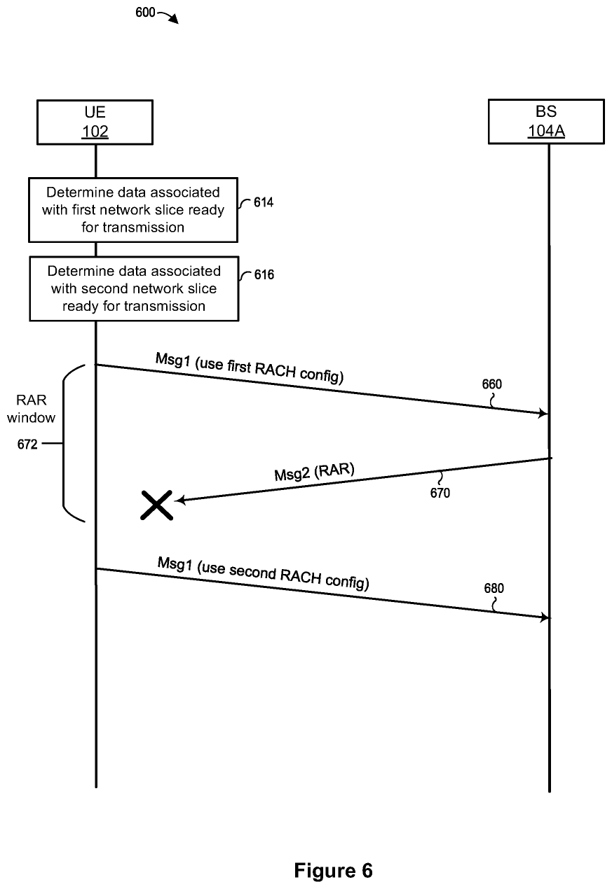

Next, various types of RAN-level procedures/functions that the base station 104A and UE 102 (and in some cases, base station 104B and/or 104C) can implement are discussed with reference to FIGS. 3-10. In particular, FIG. 3 shows an example scenario in which the base station 104A provides the UE 102 with information specifying which slice(s) the base station 104A supports, after which the UE 102 requests network support information for a different (unsupported) slice, and FIGS. 4A, 4B, and 5 show alternative RACH procedures that the UE 102 may initiate to make such a request. FIGS. 6-8 show example scenarios in which the UE 102 has data associated with multiple slices ready for uplink transmission, FIG. 9 shows an example scenario in which the base stations 104 provide the UE 102 with offsets to steer the UE 102 towards or away from their associated cells during cell selection. FIG. 10 shows an example scenario in which the base station 104A is serving the UE 102 and provides the UE 102 with one or more offsets to steer the UE 102 towards or away from the serving cell 124A and/or neighboring cells (e.g., cells 124B and 124C) during cell reselection. While FIGS. 3-10 and the accompanying descriptions refer specifically to the UE 102 and the base station 104A (and in some cases the base stations 104B and 104C) of FIG. 1, it is understood that the following techniques may be implemented by other user devices and/or base stations, and/or in systems other than the wireless communication system 100 of FIG. 1.

Referring first to FIG. 3, in an example scenario 300, the base station 104A transmits 310 to the UE 102 a slice capability message that indicates which slice, or slices, the base station 104A supports. “Support” for a particular slice may mean, for example, that the base station 104A can provide at least some minimum level of performance that the slice requires (e.g., low latency, high throughput, etc.), and/or may mean that the base station 104A recognizes the slice (i.e., knows what level of performance is required for the slice), etc. The slice support information may be a bitmap, for example, with each bit of the bitmap corresponding to a different slice (e.g., based on an ordering/mapping known to the UE 102).

In some implementations, the base station 104A broadcasts 310 the slice capability message. For example, the slice capability message may be a system information block (SIB), and may include other system information in addition to slice capability/support information (e.g., a SIB1). In other implementations, the base station 104A transmits 310 the slice capability message only to the UE 102. For example, the slice capability message may be an RRCRe configuration message that the UE 102 transmits 310 during an RRC reconfiguration procedure, in an RRCSetup message that the UE 102 transmits 310 during an RRC connection establishment procedure, in an RRCReestablishment message that the UE 102 transmits 310 during an RRC reestablishment procedure, or in an RRCResume or RRCSetup message that the UE 102 transmits 310 during an RRC connection resume procedure (e.g., as the various RRC procedures are defined in 3GPP TS 38.331). In some implementations, the slice support unit 134 generates the slice capability message, or generates the specific portion of the message that relates to slice capabilities.

At some point thereafter (or, in other implementations and/or scenarios, before event 310), the UE 102 determines 314 that data associated with a particular network slice (arbitrarily referred to in FIG. 3 as a “first” network slice) is ready for transmission. Alternatively, the UE 102 may determine 314 that data associated with the first network slice is expected to be ready for transmission soon (e.g., in response to the launch of an application that attempts to make use of the first network slice, etc.). Event 314 may include an application (e.g., at a layer implementing one of protocols 218) requesting the first network slice from the NAS controller 144 via a first IPL message, and the NAS controller 144 in turn requesting the first network slice from the AS controller 142 via a second IPL message. The data associated with the first network slice may have a slice-specific priority level that was configured by the network (e.g., by base station 104A). Alternatively, the priority level may be pre-defined (e.g., by the OEM). In either case, the NAS controller 144 may inform the AS controller 142 of the priority level for the first network slice.

The UE 102 (e.g., the AS controller 142, in response to the second IPL message) may then determine 318 whether the first network slice is supported by the serving cell 124A, by comparing the first network slice to the list of supported slices received from the base station 104A at event 310. In the example scenario 300, the UE 102 determines 318 that the first network slice is not supported by the serving cell 124A. In other scenarios, the UE 102 may instead determine 318 that the serving cell 124A does support the first network slice, in which case events 320, 330, 332, and 340 (described below) may be omitted, and the UE 102 may instead use the serving cell 124A to transmit any uplink data (and possibly receive downlink data) associated with the first network slice.

In the scenario 300, after determining 318 that the serving cell 124A does not support the first network slice, the UE 102 transmits 320 a request message to the serving base station 104A. For example, the slice support query unit 146 may trigger and/or generate the request message in response to the determination 318. In response to the request message, the base station 104A transmits 330 to the UE 102 a response message that provides network support information for the first network slice. In different implementations, the response message may be a RACH message (e.g., a MsgB or Msg2), a broadcast message (e.g., a SIB), a dedicated RRC message (e.g., an RRCReconfiguration message), or another suitable type of message.

The network support information includes information about one or more other network resources that can support the first network slice, and that the UE 102 may be able to use when communicating data associated with the first network slice. For example, the network support information may indicate a particular RAT that supports the first network slice, a frequency (e.g., channel, band, etc.) that supports the first network slice, a physical cell identifier of a neighboring cell (e.g., cell 124B and/or 124C) that supports the first network slice, a RACH configuration associated with the neighboring cell that supports the first network slice, and/or whether the neighboring cell that supports the first network slice also supports one or more other specific network slices (e.g., other slices that may also be of interest to the UE 102).

In some implementations, the serving base station 104A collects some or all of the network support information (or other information from which the base station 104A can derive the network support information) from one or more base stations of neighboring cells, before transmitting 330 the response message to the UE 102. For example, the base station 104A may receive information indicating support (or lack of support) for at least the first network slice from the base station 104B and/or the base station 104C via X2 or Xn interfaces. The base station 104A may request this information in response to receiving the request message at event 320, or may receive the information periodically, etc. In some implementations, the base station 104A also, or instead, receives such information from the CN 110 (e.g., in implementations where the CN 110 stores information on slice support at various network nodes, or in implementations where the base stations 104 communicate via the CN 110, etc.).

In some implementations, the slice support unit 134 generates the response message, or generates the specific portion of the response message that relates to network support for the first network slice. The slice support unit 134 may also collect network support information for the first network slice from neighboring base stations (e.g., base station 104B and/or 104C) and/or from the CN 110, as discussed above.

Events 320 and 330 are collectively referred to as procedure 332. The procedure 332 may be a special RACH procedure in which the request message of event 320 is a first random access message and the response message of event 330 is a second random access message. Alternative implementations of such a RACH procedure are discussed below with reference to FIGS. 4A, 4B, and 5. In other implementations, the request and response messages are not random access messages. For example, the UE 102 may transmit 320 a first RRC (or other layer) message that includes a field specifying the first network slice, and the base station 330 may respond by transmitting 330 to the UE 102 a second RRC (or other layer) message that includes one or more fields indicating network support information for the first network slice.

In some implementations and/or scenarios, the UE 102 initiates the procedure 332 (i.e., transmits 320 the request message) even if the base station 104A indicated (at event 310) support for the first network slice. For example, the UE 102 may want to learn which neighboring cells (and/or which RATs, frequencies, etc.) support the first network slice, in case the quality of the radio link between the UE 102 and the base station 104A suddenly degrades at some later time and the UE 102 must reselect to another cell.

After the UE 102 and base station 104A perform the procedure 332 to inform the UE 102 of network support for the first network slice, the UE 102 and/or the base station 104A may optionally perform 340 one or more subsequent operations. If the base station 104A informed the UE 102 that cell 124B supports the first network slice, for example, the UE 102 may in response attempt to reselect to cell 124B and establish an RRC connection with base station 104B. As another example, in an implementation and scenario where performing the procedure 332 includes performing a RACH procedure, and where the RACH procedure results in the UE 102 accessing a channel on the cell 124A, the base station 104A may use the knowledge that the UE 102 is interested in the first network slice to configure the UE 102 in a particular way (e.g., to facilitate a faster connection with another base station). For example, the base station 104A may schedule the UE 102 to make signal and/or channel quality measurements for cell 124B, thereby enabling the UE 102 to more quickly connect to the base station 104B via cell 124B than would otherwise be possible. In one such implementation, if there are reasons for the UE 102 to stay connected to the base station 104A (e.g., if the UE 102 has some data buffered at the base station 104A), the base station 104A may cause the UE 102 to simultaneously communicate with base stations 104A and 104B (e.g., in a multi-RAT dual connectivity scheme). As yet another example, if the base stations 104A and 104B both support the same RAT (e.g., 5G NR), but only a particular frequency of the base station 104B supports the first network slice, then the base station 104A may initiate carrier aggregation using a first frequency supported by the base station 104A and a second, different frequency supported by base station 104B. In still other scenarios (e.g., if no neighboring cells support the first network slice and the UE 102 decides to wait to transmit any associated data), the UE 102 may take no action and event 340 may be omitted.

In still other implementations and/or scenarios, the UE 102 does not initiate the procedure 332. For example, in response to the determination 318 that the serving cell 124A does not support the first network slice, the UE 102 may proceed to initiate a cell reselection procedure at event 340 in order to establish an RRC connection to the RAN via a different cell, without initiating the procedure 332.

In some implementations and/or scenarios, after the procedure 332 (e.g., during event 340), a (possibly new) serving base station (e.g., base station 104A, 104B, or 104C) transmits another message to the UE 102 containing slice-specific network support information (e g , similar to any of the network support information discussed above with reference to event 330). For example, the message may be an RRCReject or RRCRelease message as defined in 3GPP TS 38.331. The UE 102 may then use the network support information in the message to choose a cell on which to camp, or to establish a connection to the network.

FIGS. 4A, 4B, and 5 show alternative implementations for procedure 332 of FIG. 3. Specifically, FIGS. 4A and 4B correspond to implementations in which the procedure 332 is a four-step, contention-based RACH procedure (labeled in FIGS. 4A and 4B as procedure 432A and 432B, respectively), and FIG. 5 corresponds to an implementation in which the procedure 332 is a two-step, contention-based RACH procedure (labeled in FIG. 5 as procedure 532). In other implementations, the UE 102 and base station 104A may use a different type of RACH procedure as procedure 332.

Referring first to FIG. 4A, the UE 102 initiates a four-step, contention based RACH procedure 432A by transmitting 410A a Msg1 to the base station 104A, possibly while the UE 102 is camped on the cell 124A and in an idle or inactive state. As in a conventional RACH procedure (e.g., as specified in the 3GPP LTE or NR specification), the Msg1 includes a preamble sequence and is transmitted via a PRACH occasion. Depending on the implementation, the preamble and/or PRACH occasion may be specifically dedicated/reserved for requesting network support information for the first network slice (e.g., as discussed further below in connection with FIG. 4B), or may be a preamble and/or PRACH occasion that are also usable for standard channel access attempts.

After receiving the Msg1, the base station 104A transmits 416A a Msg2 (random access response, or “RAR”) to the UE 102. In some implementations, the Msg1 transmitted 410A by the base station 104A includes a CORESET and/or a search space. In these implementations, after the UE 102 transmits 410A the Msg1, the UE 102 detects the Msg2 (at event 416A) by using the CORESET and/or search space to detect a physical downlink control channel (PDCCH) addressed to a radio network temporary identifier (RNTI), where the PDCCH indicates the transmission of the Msg2 (RAR) from the base station 104A.

The Msg2 contains an uplink grant for the UE 102. After receiving the Msg2, the UE 102 transmits 420A a Msg3 using the uplink grant. In this implementation, the Msg3 includes an indicator of a network slice of interest to the UE 102 (arbitrarily referred to here as a “first” network slice). After receiving the Msg3 at event 420A, the base station 104A determines 425A that the Msg3 indicates the first network slice (or equivalently, that the UE 102 is requesting network support information for the first network slice).

In response to the determination 425A, the base station 104A determines 428A what network support exists for the first network slice. The base station 104A may limit the determination 428A only to network resources that can be easily accessed by the UE 102 given its current location in cell 124A. For example, the base station 104A may only determine 428A which neighboring cells, and/or which resources associated with neighboring cells (e.g., which frequencies), support the first network slice.

In some implementations, the base station 104A determines 428A the network support for the first network slice by accessing static or semi-static databases stored locally at base station 104A. In other implementations, the base station 104A determines 428A the network support for the first network slice by requesting (e.g., via X2 or Xn interfaces) that neighboring base stations 104B and 104C provide information regarding their capability to support the first network slice. In still other embodiments, the base station 104A accesses the CN 110 to determine 428A whether the neighboring base stations 104B and/or 104C support the first network slice.

After the determination 428A, the base station 104A transmits 430A to the UE 102 a Msg4 that indicates the network support that the UE 102 determined at event 428A. The network support information in the Msg4 may include any or all of the types of information discussed above in connection with event 330 of FIG. 3 (e.g., a particular RAT and/or frequency that supports the first network slice, a physical cell identifier of a neighboring cell that supports the first network slice, etc.), for example.

Referring next to FIG. 4B, the UE 102 initiates an alternative four-step, contention based RACH procedure 432B by transmitting 420B a Msg1 to the base station 104A, possibly while the UE 102 is camped on the cell 124A and in an idle or inactive state. As in a conventional RACH procedure (e.g., as specified in the 3GPP LTE or NR specification), the Msg1 includes a preamble sequence and is transmitted via a PRACH occasion. In this implementation, however, the preamble and/or PRACH occasion are specifically dedicated/reserved for requesting network support information for the first network slice. With reference to FIG. 3, for example, the base station 104A may have configured the UE 102 with a RACH configuration (e.g., a particular preamble and/or PRACH occasion) at a time before the procedure 332 begins, by transmitting a configuration (e.g., RRC or broadcast) message to the UE 102. Examples of this configuration message are discussed in further detail below.

In some implementations, the UE 102 chooses the RACH configuration (i.e., the set of RACH resources) to use for Msg1 from among multiple RACH configurations, where each RACH configuration is dedicated for checking network support for a different slice. For example, the base station 104A may have configured the UE 102 with a first RACH configuration dedicated for checking the availability of the first network slice, and configured the UE 102 with a second RACH configuration dedicated for checking the availability of a second, different network slice. In the example of FIG. 4B, the Msg1 itself may omit any information (e.g., information elements or fields) that specifies the first network slice.

After (or while) receiving the Msg1 at event 420B, the base station 104A determines 426B that the Msg1 is associated with the first network slice (or equivalently, that the UE 102 is requesting network support information for the first network slice). More specifically, in some implementations, the base station 104A determines 426B that the Msg1 is requesting network support information for a slice that is associated with the particular RACH configuration/resources (e.g., preamble and/or PRACH occasion) that the UE 102 had used to generate and transmit 420B the Msg1. The base station 104A may make this determination 426B, for example, by detecting the preamble and/or PRACH occasion used by the UE 102 to transmit 420B the Msg1, and then comparing that preamble and/or PRACH occasion to locally stored data indicating associations between (1) preambles and/or PRACH occasions, and (2) network slices.

In response to the determination 426B, the base station 104A determines 428B what network support exists for that slice. Event 428B may be similar to event 428A, for example. After determining 428B the network support information, the base station 104A transmits 430B a Msg2 (random access response, or “RAR”) to the UE 102. The Msg2 may be similar to the Msg2 of a conventional four-step, contention-based RACH procedure, but is modified to include an indication of the network support information as determined 428B by the base station 104A. For example, the Msg2 may include an additional field or fields that include the network support information. The network support information may include any or all of the types of information discussed above in connection with event 330 of FIG. 3 (e.g., a particular RAT and/or frequency that supports the first network slice, a physical cell identifier of a neighboring cell that supports the first network slice, etc.), for example.

The RACH procedure that the UE 102 initiates to request network support information for the first network slice may or may not be a full RACH procedure (i.e., may or may not have the potential to result in channel access and/or transition the UE 102 to a connected state). In implementations where the UE 102 does not use the RACH procedure 432B to make a channel access attempt, the base station 104A may not perform any HARQ procedure, and/or procedure 432B may end after the base station 104A transmits 430B the Msg2 (or after the UE 102 processes the received Msg2 to identify the network support for the first network slice). In other implementations and/or scenarios, however, in response to receiving the Msg2 at event 430B, the UE 102 transmits 431B a Msg3 containing a scheduled transmission to the base station 104A. In response to the Msg3, the base station 104A transmits 433B a Msg4 to indicate contention resolution to the UE 102.

In some implementations, the Msg1 transmitted 420B by the base station 104A includes a CORESET and/or a search space. In these implementations, after the UE 102 transmits 420B the Msg1, the UE 102 detects the Msg2 (at event 430B) by using the CORESET and/or search space to detect a PDCCH addressed to an RNTI, where the PDCCH indicates the transmission of the Msg2 (RAR) from the base station 104A.

In an alternative implementation, the base station 104A provides the network support information at event 430B by broadcasting system information (e.g., in a SIB) rather than sending Msg2 (or in addition to sending a Msg2 without network support information, if the RACH procedure 432 is used for channel access). If the RACH procedure 432B is still ongoing when the UE 102 receives the broadcast system information, the UE 102 terminates the RACH procedure 432B.

Referring next to FIG. 5, in another alternative implementation of event 332 in FIG. 3, the UE 102 initiates a two-step, contention based RACH procedure 532 by transmitting 520 a MsgA to the base station 104A, possibly while the UE 102 is camped on the cell 124A and in an idle or inactive state. As in a conventional two-step RACH procedure (e.g., as specified in the 3GPP 5G NR specification), the MsgA includes two parts sent on different occasions: a preamble sequence that is transmitted 522 via a PRACH occasion (e.g., similar to Msg1 of FIG. 4A), and a payload that is transmitted 524 via a PUSCH occasion (e.g., similar to Msg3 of FIG. 4B). In this implementation, however, the preamble and/or PRACH occasion are dedicated/reserved for requesting network support information for the first network slice. Alternatively, or in addition, the PUSCH occasion for the MsgA payload may be dedicated for such requests. That is, the preamble and/or PRACH occasion (and possibly the PUSCH occasion for the MsgA payload) may be resources that the base station 104A had included in a RACH configuration dedicated for such requests. With reference to FIG. 3, for example, the base station 104A may have configured the UE 102 with a RACH configuration (e.g., a particular preamble and/or PRACH occasion) at a time before the procedure 332 begins, by transmitting a configuration (e.g., RRC or broadcast) message to the UE 102. Examples of this configuration message are discussed in further detail below.

In some implementations, the UE 102 chooses the RACH configuration (i.e., the set of RACH resources) to use for MsgA from among multiple RACH configurations, where each RACH configuration is dedicated/reserved for checking network support for a different slice. For example, the base station 104A may have configured the UE 102 with a first RACH configuration dedicated for checking the availability of the first network slice, and configured the UE 102 with a second RACH configuration dedicated for checking the availability of a second, different network slice. In the example of FIG. 5, the MsgA itself may omit any information (e.g., information elements or fields) that specifies the first network slice.

In other implementations, the base station 104A only configures the UE 102 with a single RACH configuration for requesting slice-specific network support information, and the UE 102 uses the contents of the MsgA to indicate the specific slice that the UE 102 desires (e.g., needs or expects) to use. For example, the UE 102 may include a field or information element in the MsgA payload, indicating the slice of interest.

After (or while) receiving the MsgA at event 520, the base station 104A determines 526 that the MsgA is associated with the first network slice (or equivalently, that the UE 102 is requesting network support information for the first network slice). In implementations where the base station 104A configured the UE 102 with a different RACH configuration for each of a plurality of network slices, the base station 104A may determine 526 the precise slice (here, the “first” network slice) by detecting the preamble and/or PRACH occasion (and/or PUSCH occasion) of the MsgA, and then comparing that preamble and/or PRACH occasion (and/or PUSCH occasion) to locally stored data indicating associations between (1) preambles and/or PRACH occasions (or PUSCH occasions), and (2) network slices.

However, in implementations where the base station 104A had configured the UE 102 with a single RACH configuration to handle network support requests for any of multiple different slices, the base station 104A may determine 526 the slice of interest by (1) first detecting the RACH configuration used to generate and/or transmit 520 the MsgA (e.g., preamble, PRACH occasion, and/or PUSCH occasion), and then (2) in response to determining that the RACH configuration is generally reserved for requesting slice support information, inspecting the MsgA payload to identify the specific slice of interest (here, the “first” network slice) in the appropriate field or information element.

Having identified the MsgA as a request for network support information for the first network slice, the base station 104A proceeds to determine 528 the network support information for that slice. Event 528 may be similar to event 428A of FIG. 4A, for example.

After determining 528 the network support information, the base station 104A transmits 530 a MsgB to the UE 102. The MsgB may be similar to the MsgB of a conventional two-step, contention-based RACH procedure, but is modified to include an indication of the network support information as determined 528 by the base station 104A. For example, the MsgB may include an additional field or fields that include the network support information. The network support information may include any or all of the types of information discussed above in connection with event 330 of FIG. 3 (e.g., a particular RAT and/or frequency that supports the first network slice, a physical cell identifier of a neighboring cell that supports the first network slice, etc.), for example.

The RACH procedure that the UE 102 initiates to request network support information for the first network slice may or may not be a full RACH procedure (i.e., may or may not have the potential to result in channel access and/or transition the UE 102 to a connected state). In implementations where the UE 102 does not use the dedicated RACH procedure 532 to make a channel access attempt, the base station 104A may generate and transmit 530 the MsgB without performing other operations typically associated with contention-based RACH procedures (e.g., HARQ procedures). In other implementations, however, the UE 102 and base station 104A may perform a full two-step, contention-based RACH procedure, possibly leading to channel access and/or causing the UE 102 to enter a connected state with respect to the cell 124A and the base station 104A.

In an alternative implementation, the base station 104A provides the network support information at event 530 by broadcasting system information (e.g., in a SIB) rather than sending a MsgB (or in addition to sending a MsgB without network support information, if the RACH procedure 532 is used for channel access). If the RACH procedure 532 is still ongoing when the UE 102 receives the broadcast system information, the UE 102 terminates the RACH procedure 532.

As noted above, for either procedure 432B or procedure 532 (or possibly procedure 432A), the base station 104A may configure the UE 102 with the dedicated RACH configuration(s) by sending one or more configuration messages to the UE 102. For example, the base station 104A may specify the dedicated RACH configuration(s) in a SIB that the base station 104A broadcasts on the cell 124A (e.g., a SIB1). Alternatively, the base station 104A may specify the RACH configuration(s) in a dedicated RRC message, such as an RRCRelease message that the base station 104A sends to the UE 102 when the UE 102 is transitioning from a connected state to an idle state. In still other implementations and/or scenarios, the base station 104A specifies the RACH configuration(s) in another suitable type of message or messages (e.g., in a master information block (MIB), in an RRCReconfiguration message that the base station 104A sends to the UE 102 in an RRC reconfiguration procedure, in an RRCSetup message that the base station 104A sends to the UE 102 in an RRC connection establishment procedure, in an RRCReestablishment message that the base station 104A sends to the UE 102 in an RRC reestablishment procedure, in an RRCResume or RRCSetup message that the base station 104A sends to the UE 102 in an RRC connection resume procedure, etc.). In some implementations, the base station 104A sends the dedicated RACH configuration(s) in the same message that includes the slice capability information transmitted at event 310.

The configuration message(s) sent by the base station 104A may include, for each dedicated, slice-specific RACH configuration, a particular preamble and/or PRACH occasion. In some implementations, the configuration message(s) may also include other information. For example, each RACH configuration may include a maximum number of allowed preamble transmission attempts before the UE 102 should conclude that the radio link has failed. In another example, each RACH configuration may include the type of RACH procedure that the UE 102 is to perform (e.g., two-step or four-step). In still other examples, each RACH configuration may include a RAR window length (e.g., a time period over which the UE 102 should try to receive a RAR from the base station 104A and then, if unsuccessful, select and transmit a new preamble), a MsgB response window length (e.g., a time period over which the UE 102 should try to receive a MsgB from the base station 104A and then, if not receiving a MsgB that contains both an identifier of the preamble in the MsgA and a common control channel (CCCH) service data unit (SDU), consider the RACH procedure to be unsuccessful), or a contention resolution time (e.g., a time period over which the UE 102 should try to detect a PDCCH addressed to the appropriate C-RNTI, or receive a message that includes a contention resolution identity MAC control element (CE) from the base station 104A and then, if unsuccessful, consider the RACH procedure to be unsuccessful and make another attempt to transmit a preamble). In still other examples, each RACH configuration may include a power increment (ramping step) for successive preamble transmissions by the UE 102 (i.e., for each re-attempt of a failed RACH procedure), and/or a back-off factor to be used by the UE 102 when performing back-off in a RACH procedure (e.g., with the UE 102 selecting a back-off value between zero and a maximum value provided by the base station 104A, and multiplying the back-off value by the back-off factor).

In some implementations, if the UE 102 is served by or camped upon cell 124A and requests that the base station 104A transmit information related to a desired slice, and if the base station 104A supports that slice, the base station 104A transmits a configuration message with a RACH configuration for the UE 102 to use when accessing a channel of cell 124A. The configuration message may include any of the types of RACH configuration information discussed above (e.g., a particular preamble and/or PRACH occasion, a maximum number of allowed preamble transmission attempts, etc.), for example.

FIGS. 6-8 show example scenarios in which the UE 102 is ready to transmit uplink data associated with two different slices at the same time (or at overlapping times, etc.), and in which the base station 104A supports (or may support) both of those slices. In these cases, the UE 102 may need to prioritize its attempts to gain channel access for the data associated with the different slices. Each of the scenarios in FIGS. 6-8 may occur instead of the procedure 332, 432A, 432B, or 532, for example (e.g., if the slice capability message the UE 102 received at event 310 indicated support for both slices). Alternatively, each of the scenarios in FIGS. 6-8 may be implemented by the base station of a different cell (e.g., by base station 104B or 104C) after the procedure 332, 432A, 432B, or 532, and after the UE 102 reselected to a different cell that provides support for both slices (e.g., cell 124B or 124C).

Referring first to scenario 600 of FIG. 6, the UE 102 determines 614 that data associated with a first network slice is ready for transmission, and determines 616 that data associated with a different, second network slice is also ready for transmission. Events 614 and 616 may each be similar to event 314 of FIG. 3, for example, and may occur in either order or at the same time. In some implementations and scenarios, event 616 may occur after the first RACH procedure has started (e.g., after event 660 but before event 680, both discussed below).

In the scenario 600, the UE 102 decides to attempt channel access for the data associated with the first network slice before attempting channel access for the data associated with the second network slice. The UE 102 may determine this order based on the first network slice (or its associated data) having a higher priority than the second network slice (or its associated data), because the determination 614 occurred before the determination 616, and/or for a different reason. To obtain channel access for the first network slice data, the UE 102 initiates a four-step RACH procedure. Specifically, the UE 102 transmits 660 a Msg1 using a first RACH configuration (e.g., a first preamble sent on a first PRACH occasion), and the base station 104A responds by transmitting 670 a Msg2 (RAR). The Msg2 may also contain an identifier of the preamble that the UE 102 used to transmit 660 the Msg1.

In the scenario 600, the UE 102 does not receive the Msg2 in a RAR window 672. While FIG. 6 shows the base station 104A transmitting 670 the Msg2 and the UE 102 not successfully receiving the transmitted Msg2, in other scenarios the base station 104A does not receive the Msg1, in which case event 670 does not occur. In either case, in response to the UE 102 detecting that the RAR window 672 ended without receiving a Msg2 (or at least, without receiving a Msg2 containing the appropriate preamble identifier), the UE 102 decides to instead select a new preamble and/or PRACH occasion, and attempts to access the channel using this new RACH configuration. FIG. 6 shows only the beginning of this subsequent RACH procedure, in which the UE 102 transmits 680 a Msg1 using the new RACH configuration. The UE 102 then waits for the base station 104A to respond with a Msg2 within another RAR window, and so on.

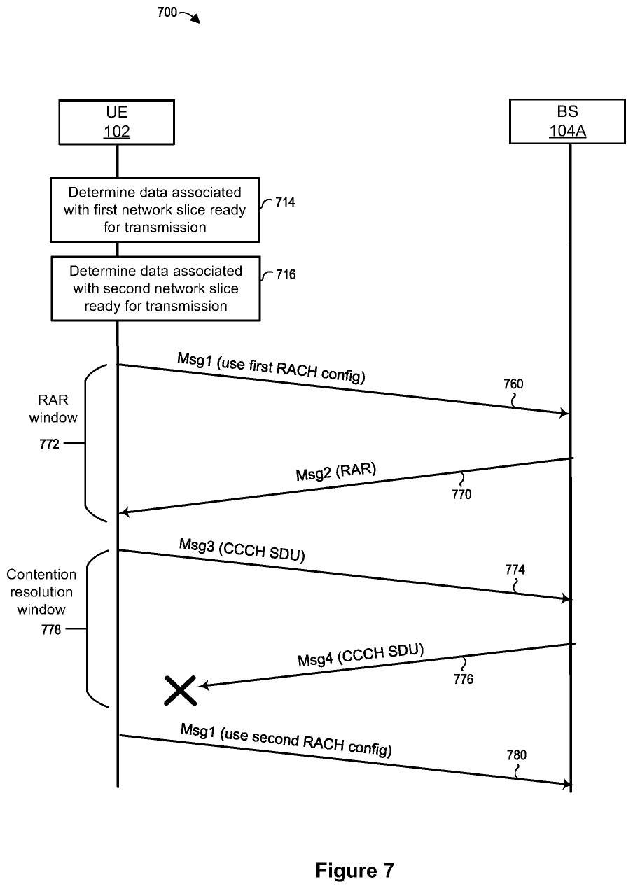

Referring next to scenario 700 of FIG. 7, the UE 102 determines 714 that data associated with a first network slice is ready for transmission, and determines 716 that data associated with a different, second network slice is also ready for transmission. Events 714 and 716 may each be similar to event 314 of FIG. 3, for example, and may occur in either order or at the same time. In some implementations and scenarios, event 716 may occur after the first RACH procedure has started (e.g., after event 760 but before event 780, both discussed below).

In the scenario 700, the UE 102 decides to attempt channel access for the data associated with the first network slice before attempting channel access for the data associated with the second network slice. The UE 102 may determine this order based on the first network slice (or its associated data) having a higher priority than the second network slice (or its associated data), because the determination 714 occurred before the determination 716, and/or for a different reason. To obtain channel access for the first network slice data, the UE 102 initiates a four-step RACH procedure. Specifically, the UE 102 transmits 760 a Msg1 using a first RACH configuration (e.g., a first preamble sent on a first PRACH occasion), and the base station 104A responds by transmitting 770 a Msg2 (RAR). The Msg2 may also contain an identifier of the preamble that the UE 102 used to transmit 760 the Msg1.

In response to receiving the Msg2 with the appropriate preamble identifier (within a RAR window 772), the UE 102 transmits 774 a Msg3 containing a CCCH SDU to the base station 104A, using an uplink grant that the base station 104A included in the Msg2. In response, the base station 104A transmits 776 a Msg4 containing the CCCH SDU to the UE 102. In the scenario 700, the UE 102 does not receive the Msg2 in a contention resolution window 778. While FIG. 7 shows the base station 104A transmitting 776 the Msg4 and the UE 102 not successfully receiving the transmitted Msg4, in other scenarios the base station 104A does not receive the Msg3, in which case event 776 does not occur. In either case, in response to the UE 102 detecting that the contention resolution window 778 ended without receiving a Msg4 (or at least, without receiving a Msg4 containing the appropriate CCCH SDU), the UE 102 decides to instead select a new preamble and/or PRACH occasion, and attempts to access the channel using this new RACH configuration. FIG. 7 shows only the beginning of this subsequent RACH procedure, in which the UE 102 transmits 780 a Msg1 using the new RACH configuration. The UE 102 then waits for the base station 104A to respond with a Msg2 within another RAR window, and so on.

Referring next to scenario 800 of FIG. 8, the UE 102 determines 814 that data associated with a first network slice is ready for transmission, and determines 816 that data associated with a different, second network slice is also ready for transmission. Events 814 and 816 may each be similar to event 314 of FIG. 3, for example, and may occur in either order or at the same time. In some implementations and scenarios, event 816 may occur after the first RACH procedure has started (e.g., after event 862 but before event 882, both discussed below).

In the scenario 800, the UE 102 decides to attempt channel access for the data associated with the first network slice before attempting channel access for the data associated with the second network slice. The UE 102 may determine this order based on the first network slice (or its associated data) having a higher priority than the second network slice (or its associated data), because the determination 814 occurred before the determination 816, and/or for some other reason. To obtain channel access for the first network slice data, the UE 102 initiates a two-step RACH procedure. Specifically, the UE 102 transmits 862 a MsgA using a first RACH configuration (e.g., a first preamble sent on a first PRACH occasion), and the base station 104A responds by transmitting 872 a MsgB (RAR). The MsgA may include a preamble and a CCCH SDU, and the MsgB may contain an identifier of the preamble that the UE 102 used to transmit 862 the MsgA.

In the scenario 800, the UE 102 does not receive the MsgB in a MsgB window 873. While FIG. 8 shows the base station 104A transmitting 872 the MsgB and the UE 102 not successfully receiving the transmitted MsgB, in other scenarios the base station 104A does not receive the MsgA, in which case event 872 does not occur. In either case, in response to the UE 102 detecting that the MsgB window 873 ended without receiving a MsgB (or at least, without receiving a MsgB containing the appropriate preamble identifier), the UE 102 decides to instead select a new preamble and/or PRACH occasion, and attempts to access the channel using this new RACH configuration. FIG. 8 shows only the beginning of this subsequent RACH procedure, in which the UE 102 transmits 882 a MsgA using the new RACH configuration. The UE 102 then waits for the base station 104A to respond with a MsgB within another MsgB window, and so on.

Other implementations and scenarios, other than those shown in FIGS. 6-8, are also possible. In some implementations, for example, if the UE 102 begins a first RACH procedure using a first RACH configuration (to attempt channel access for data associated with a first network slice), and the UE 102 determines during the first RACH procedure that second data associated with a second network slice is ready for transmission, the UE 102 then terminates the first RACH procedure and instead starts a second RACH procedure to attempt channel access for the second network slice data. This can happen, for example, if the UE 102 determines that the second network slice and/or its associated data has a higher priority than the first network slice and/or its associated data.

In some implementations, if the UE 102 initiates a RACH procedure with a serving base station (e.g., base station 104A) to attempt channel access for uplink data associated with a particular slice, and the UE 102 either selects or reselects a cell during the RACH procedure, the UE 102 terminates the RACH procedure. The UE 102 may then initiate another RACH procedure on the selected or reselected cell. In another scenario, if the UE 102 initiates a RACH procedure with a serving base station (e.g., base station 104A) to attempt channel access for uplink data associated with a particular slice, and the serving cell 124A becomes unsuitable (e.g., due to channel quality degradation), the UE 102 may terminate the ongoing RACH procedure.

In some implementations, the RAN uses offsets to steer UEs towards or away from particular cells based on whether those cells support network slices that the UEs need (or prefer, expect, etc.) to make use of. To this end, a base station (e.g., base station 104A, 104B, or 104C) can transmit offsets for use in cell selection and/or offsets for use in cell reselection.

FIG. 9 shows an example scenario 900 in which base stations 104A through 104C provide the UE 102 with offsets to steer the UE 102 towards or away from the associated cells (i.e., cells 124A through 124C) during cell selection. As seen in FIG. 9, the base station 104A transmits 910A a first slice capability message to the UE 102, the base station 104B transmits 910B a second slice capability message to the UE 102, and the base station 104C transmits 910C a third slice capability message to the UE 102. Each of the slice capability messages may be broadcast by the respective one of the base stations 104, and may be similar to the slice capability message transmitted at event 310. For example, the slice capability messages may be SIBs (e.g., SIB1s) that indicate which network slice(s) are supported by the respective base stations 104.

In addition, in the implementation of FIG. 9, the slice capability messages each specify one or more cell selection offsets, which the UE 102 can use when calculating values for cell suitability (e.g., by modifying the S-criteria as defined in TS 38.304). Generally, the suitability of a given cell may depend on both the slice(s) desired by the UE 102 and the slice(s) supported by that cell. In other implementations, the base stations 104 transmit (e.g., broadcast) their slice-related offsets separately from their indications of supported slices. While the techniques below refer to a single cell per base station, in some implementations and scenarios a base station can transmit (e.g., broadcast) a different cell selection offset, or a different set of cell selection offsets, for each of multiple cells associated with that base station.

At some point after or during events 910A through 910C, the UE 102 decides to select a cell. For example, the UE 102 may decide to select a cell upon power-up of the UE 102, or in response to the UE 102 determining that data is ready for uplink transmission, etc. In some implementations, the UE 102 determines that a cell is suitable for cell selection if the cell (1) satisfies the S-criteria (i.e., the criteria for a given cell to be “suitable” for selection) as defined in TS 38.304 (or other criteria based at least in part on cell measurements), and (2) supports at least some threshold number of slices of interest to the UE 102 (e.g., at least one desired slice, or all desired slices, etc.). In these implementations, the slice capability messages sent at events 910A through 910C may omit offsets, and only include the indications of supported slices.

In the depicted implementation, however, the UE 102 determines 916 cell suitability values in part based on the one or more of the offsets received from the base stations 104. In one such implementation, the base stations 104 broadcast (at events 910A through 910C) positive offsets that steer UEs towards the respective cells 124 if those cells 124 support one or more slices desired by the UEs. In one such implementation, the S-criterion is that Srxlev and Squal both be greater than zero, where Srxlev and Squal are defined as:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ+RSNoffset; and

Squal=Q_{qualmeas}−(Q_{qualmin}+Q_{qualminoffset})−Qoffsetₜₑₘₚ+RSNoffset.

In the above equations, Srxlev is a cell selection receive level value and Squal is a cell selection quality value (both expressed in dB), while Qᵣₓₗₑᵥₘₑₐₛ is a measured cell receive level value (reference signal received power or RSRP) and Q_{qualmeas} is a measured cell quality value (reference signal received quality or RSRQ). Qᵣₓₗₑᵥₘᵢₙ, Q_{qualmin}, Q_{rxlevminoffset}, Q_{qualminoffset}, P_{compensation}, and Qoffsetₜₑₘₚ are defined in TS 38.304. RSNoffset is the offset for which the base stations 104 broadcast specific values at events 910A through 910C, to steer UEs (e.g., UE 102) towards the respective cells 124 in situations where the base stations 104 and cells 124 support at least one desired slice. For example, when calculating Srxlev and Squal for the cell 124A, the UE 102 applies (adds) RSNoffset if the cell 124A supports at least one slice of interest to the UE 102, and does not apply RSNoffset otherwise. While this and other implementations for cell selection are shown with the same offset being applied for both Srxlev and Squal, it is understood that UEs can use different offsets for Srxlev and Squal (or only use slice-related offsets for one of the two, etc.).

In another implementation, the base stations 104 broadcast (at events 910A through 910C) negative offsets that steer UEs away from the respective cells 124 if those cells 124 do not support any slices desired by the UEs. In one such implementation, the S-criterion is that Srxlev and Squal both be greater than zero, where Srxlev and Squal are defined as:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ+RSNoffset; and

Squal=Q_{qualmeas}−(Q_{qualmin}+Q_{qualminoffset})−Qoffsetₜₑₘₚ+RSNoffset.

where RSPoffset is the cell-specific value that the base stations 104 broadcast at events 910A through 910C, to steer UEs (e.g., UE 102) away from cells 124 in situations where the cells 124 do not support any slice of interest to a given UE. For example, when calculating Srxlev and Squal for the cell 124A, the UE 102 applies (subtracts) RSPoffset if the cell 124A does not support at least one slice of interest to the UE 102, and does not apply RSPoffset otherwise. In some implementations, the base stations 104 broadcast (at events 910A through 910C) both positive RSNoffset and RSPoffset values at the same time, such that a given UE (e.g., UE 102) can apply (add) RSNoffset if the respective cell supports at least one slice of interest to the UE, or instead apply (subtract) RSPoffset if the respective cell does not support at least one slice of interest to the UE.

In other implementations, the base stations 104 broadcast (at events 910A through 910C) slice-specific offsets in order to provide the network with finer control over cell selection. For example, a given cell that supports k slices may broadcast k respective offsets (e.g., at one of events 910A through 910C), RSoffsetᵢ, where 1≤i≤k. If the UE 102 desires j slices, and if m represents the slices (from among the j desired slices) that the cell supports, then the offsets that correspond to these m “overlapping” slices can be labeled as RSoffsetₗ, where 1≤l≤m. In one such implementation, the S-criterion is that Srxlev and Squal both be greater than zero, where Srxlev and Squal are defined as:

Srxlev=Qᵣₓₗₑᵥₘₑₐₛ−(Qᵣₓₗₑᵥₘᵢₙ+Q_{rxlevminoffset})−P_{compensation}−QoffsetₜₑₘₚΣₗ₌₁^{m}RSNoffsetₗ; and

Squal=Q_{qualmeas}−(Q_{qualmin}+Q_{qualminoffset})−Qoffsetₜₑₘₚ+Σₗ₌₁^{m}RSNoffsetₗ.

In addition to the slice-specific offsets, each cell may broadcast an offset, RSoffset, that the UE 102 can apply (subtract) when the cell supports none of the slices desired by UE 102 (e.g., as shown above for RSPoffset). Depending on the implementation and/or scenario, the offsets Σₗ₌₁^{m} RSoffset_{l and the offset RSoffset may be either added or subtracted (i.e., similar to RSNoffset or RSPoffset) when calculating Srxlev and Squal, depending on the network preference of “steering towards” or “steering away” from slices that do or do not support a desired slice. In some implementations, for example, m may instead be defined as the number of desired slices that are not supported by the cell, in which case the Σ}ₗ₌₁^{m} RSoffsetₗ values may be subtracted from (rather than added to) Srxlev and Squal, and RSoffset may be added to (rather than subtracted from) Srxlev and Squal.

In other implementations, the base stations 104 broadcast (at events 910A through 910C) slice-specific offsets, RSoffsetᵢ (1≤i≤k), and the UE 102 uses another operation (other than summing) to merge the slice-specific offsets. For example, the UE 102 may calculate Srxlev and Squal as:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ+RSNoffset; and

Squal=Q_{qualmeas}−(Q_{qualmin}+Q_{qualminoffset})−Qoffsetₜₑₘₚ+RSNoffset,

where RSMergedOffset is a value that the UE 102 determines based on the m desired slices that are also supported by the cell. In one implementation, RSMergedOffset is the minimum offset from among all offsets RSoffsetₗ, 1≤l≤m. In another implementation, RSMergedOffset is the maximum offset from among all offsets RSoffsetₗ, 1≤l≤m. Again, each cell may also broadcast an offset, RSoffset, that the UE 102 can apply when the cell supports none of the slices desired by UE 102, and/or m may instead be defined as the number of desired slices that are not supported by the cell.

In still other implementations, the base stations 104 broadcast (at events 910A through 910C) slice-specific offsets, RSoffseti (1≤i≤k), and the UE 102 weights the offsets for the desired slices that are supported by the cell. For example, the UE 102 may calculate Srxlev and Squal as:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ+Σₗ₌₁^{m}RSoffsetₗ*Wₗ; and

Squal=Q_{qualmeas}−(Q_{qualmin}+Q_{qualminoffset})−Qoffsetₜₑₘₚ+Σₗ₌₁^{m}RSoffsetₗ*Wₗ,

where Wₗ is the weight that the UE 102 applies for the l-th offset (RSoffsetₗ). The network may have assigned the slice-specific weights via dedicated signaling (e.g., in an RRCRelease message from one of base stations 104). Again, each cell may also broadcast an offset, RSoffset, that the UE 102 can apply when the cell supports none of the slices desired by UE 102, and/or m may instead be defined as the number of desired slices that are not supported by the cell.

In other implementations, the UE 102 applies the slice-related (e.g., slice-specific) offsets that the UE 102 receives from the base stations 104 in other ways, and/or applies the offsets to different S-criteria.

After determining 916 the cell suitability values, the UE 102 selects 917 a cell based on those values. For example, the UE 102 may limit consideration to the cells that satisfied the suitability criteria (e.g., Srxlev and Squal both greater than zero after applying all appropriate offsets), and then select a cell from those that remain using any other suitable criteria (e.g., the cell with the greatest Srxlev and/or Squal values, or the cell that supports the greatest number of slices that the UE 102 needs or expects to use, etc.).

FIG. 10 shows an example scenario 1000 in which the (serving) base station 104A provides the UE 102 with one or more offsets to steer the UE 102 towards or away from the serving cell 124A and/or neighboring cells (e.g., cells 124B, 124C) during cell reselection. As seen in FIG. 10, the base station 104A transmits 1010 a slice capability message to the UE 102. The slice capability message may be broadcast by the base station 104A, or included in a dedicated RRC message, for example. The slice capability message may be similar to the slice capability message transmitted at event 310. For example, the slice capability message may be a SIB (e.g., SIB1s), or an RRCReconfiguration message, etc., that indicates which network slice(s) are supported by the base station 104A.

In addition, in the implementation of FIG. 10, the slice capability message specifies one or more cell reselection offsets, which the UE 102 can use when calculating ranks for the serving cell 124A and/or neighboring cells (e.g., cells 124B, 124C) (e.g., by modifying the rank formulas as defined in TS 38.304). Unlike the cell selection scenario 900 discussed above, in the cell reselection scenario 1000, the serving base station 104A provides the offsets not just for itself, but also for the other cells that the UE 102 will consider (here, cells 124B and 124C). Generally, the rank of a given cell may depend on both the slice(s) desired by the UE 102 and the slice(s) supported by that cell. In some implementations, the base station 104A transmits the slice-related offset(s) separately from its indication of supported slices. The slice capability message (or a different message from the base station 104A) may also specify a “favored” cell list, discussed in further detail below. While the techniques below refer to a single cell per base station, in some implementations and scenarios a base station can transmit (e.g., broadcast) a different cell reselection offset, or a different set of cell reselection offsets, for each of multiple cells associated with that base station, and/or transmit a different favored cell list for each of the multiple cells.

At some point after or during event 1010, the UE 102 decides to perform a cell reselection procedure. For example, the UE 102 may decide to perform the cell reselection procedure in response to the quality of a communication channel in cell 124A degrading. To perform the cell reselection procedure, the UE 102 determines 1018 cell ranks for the serving cell 124A and one or more neighboring cells (in this example, cells 124B and 124C) based in part on the cell reselection offsets received from the base station 104A. In one such implementation, the base station 104A transmits 1010 positive offsets that steer UEs towards the respective cells 124 if those cells 124 support one or more slices desired by the UEs. For example, the cell-ranking criterion for the serving cell may be that Rs be greater than zero, where Rs is defined as:

Rs=Q_{meas,s}+Q_{hyst}−Qoffsetₜₑₘₚ+RSNoffset

In the above equations, Q_{meas,s} is the measured serving cell receive level value (RSRP). Q_{meas,s}, Q_{hyst}, and Qoffsetₜₑₘₚ are defined in TS 38.304. RSNoffset is the value that the base station 104A transmits 1010 to steer UEs (e.g., UE 102) towards cell 124A if the cell 124A supports at least one slice of interest to the UEs. For example, when calculating Rs for the cell 124A, the UE 102 applies (adds) RSNoffset if the cell 124A supports at least one slice of interest to the UE 102, and does not apply RSNoffset otherwise.

As discussed above in connection with cell selection, other implementations are also possible. For example, the UE 102 may instead subtract an offset (e.g., RSPoffset) from Rs in scenarios where the serving cell 124A does not support any slices desired by the UE 102. As another example, the UE 102 may instead determine a total cell reselection offset based on the slice-specific offsets for the slices that the UE 102 desires and the cell 124A supports (or, if the offset is subtracted from the rank, for those slices that the UE 102 desires but the cell 124A does not support). For example, the UE 102 may determine Rs by adding or subtracting Σₗ₌₁^{m} RSoffsetₗ, RSMergedOffset, or Σₗ₌₁^{m} RSoffsetₗ*Wₗ, in the same manner as discussed above with respect to Srxlev and Squal for cell selection.

The UE 102 also determines 1018 cell ranks for neighboring cells (here, cells 124B and 124C) using the slice-related offsets received at event 1010. Unlike in the cell selection scenario 900, however, the neighboring base stations 104B, 104C do not (at least directly) inform the UE 102 of which slices they support. In some implementations, therefore, the base station 104A includes in its slice capability message of event 1010 (or in another message) a list of which neighboring cells are favored, where a “favored” neighboring cell is one that supports the same slices as the serving cell (in this case, the same slices as serving cell 124A). In different implementations, the base station 104A also includes an indication of which neighboring cells are “unfavored” (i.e., which neighboring cells do not support the same slices as the serving cell), or does not include such an indication, in which case the UE 102 may simply assume that any cell not on the favored list is an unfavored cell. In some implementations, “favored” cells are not necessarily cells that support precisely the same set of slices as the serving cell 124A. For example, a favored cell may be any neighboring cell that supports at least one slice that the serving cell 124A supports, or any neighboring cell that supports all essential slices that the serving cell 124A supports, etc.

In implementations where “favored” status means that a neighboring cell supports the same slices as the serving cell 124A, the UE 102 can calculate a rank for a given neighboring cell based on (1) whether the serving cell 124A supports any slices of interest to the UE 102, and (2) whether the neighboring cell is favored. If the serving cell 124A does support at least one desired slice and the neighboring cell is favored, then the UE 102 can determine the rank for the neighboring cell in the same manner as for the serving cell 124A. For example, the UE 102 may calculate Rn for such a cell by adding RSNoffset to the sum (Q_{meas,s}+Q_{hyst}−Qoffsetₜₑₘₚ), or by not subtracting RSPoffset (or by adding or not subtracting Σₗ₌₁^{m} RSoffsetₗ, RSMergedOffset, or Σₗ₌₁^{m} RSoffsetₗ*Wₗ, etc.), depending on which of these techniques (discussed above) the UE 102 uses to rank the neighboring cell. If the serving cell 124A supports at least one desired slice but the neighboring cell is unfavored, then the UE 102 may determine the rank for the neighboring cell in a different manner than for the serving cell 124A. For example, the UE 102 may calculate Rn for such a cell by subtracting RSPoffset, or by not adding RSNoffset (or by subtracting or not adding Σₗ₌₁^{m} RSoffsetₗ, RSMergedOffset, or Σₗ₌₁^{m} RSoffsetₗ*Wₗ, etc.), depending on which of these techniques (discussed above) the UE 102 uses to rank the neighboring cell.

In other implementations, the UE 102 applies the slice-related (e.g., slice-specific) offsets that the UE 102 receives from the base stations 104 in other ways, and/or applies the offsets to different cell ranking criteria.

After determining 1018 the serving and neighboring cell ranks, and based on those ranks, the UE 102 either reselects to a new cell (e.g., cell 124B or 124C) or remains on the serving cell 124A at an event 1019. For example, the UE 102 may decide to reselect to (or remain on) the cell with the highest rank. In some implementations, the user device also uses a set of frequency-specific priorities to determine which cell (if any) to reselect to. For example, the set of priorities may be one that the base station 104A indicated to the UE 102 by providing an index or geographic tag value, as discussed above in connection with FIG. 1.

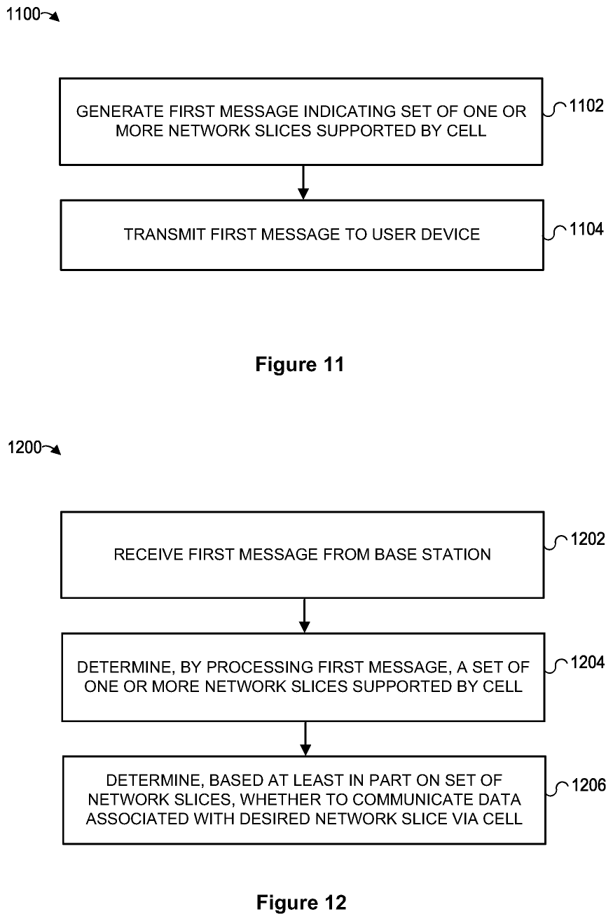

FIGS. 11 and 12 show example methods for informing a user device of which slice(s) is/are supported by a base station.

Referring first to FIG. 11, an example method 1100 can be implemented in a base station (e.g., base station 104A) configured to communicate with a user device (e.g., UE 102) located in a coverage area of a cell associated with the base station (e.g., cell 124A). For example, the method 1100 may be implemented in whole or in part by processing hardware 130 of base station 104A.

At block 1102, the base station generates a first message (e.g., the message of event 310, 910A, or 1010) indicating a set of one or more network slices supported by the cell associated with the base station. At block 1104, the base station transmits (e.g., broadcasts, or transmits in a dedicated RRC message, etc.) the first message to the user device (e.g., event 310, 910A, or 1010).

In some implementations and/or scenarios, the method 1100 includes one or more additional blocks not shown in FIG. 11. For example, the method 1100 may include a first additional block in which the base station receives a request message from the user device (e.g., event 320, 420A, 420B, or 520), and a second additional block in which the base station, in response to the request message, transmits to the user device a second message including information regarding network support for a desired network slice (e.g., event 330, 430A, 430B, or 530). The method 1100 may also include an additional block, occurring before block 1104, in which the base station receives network support information relating to the desired network slice from a neighboring base station (e.g., base station 104B) via an X2 or Xn interface.

In some implementations, if the request message is a first random access message (e.g., Msg1 or MsgA) and the response message transmitted by the base station is a second random access message (e.g., Msg2 or MsgB), the method 1100 includes an additional block in which the base station determines that the first random access message is associated with the desired network slice (e.g., event 425A, 426B, or 526). The method 1100 may further include an additional block (prior to the base station receiving the first random access message) in which the base station transmits to the user device another message indicating one or more RACH configurations, including a slice-specific RACH configuration for the user device to use when generating and transmitting the first random access message. Alternatively, the RACH configuration(s) may be included in the first message that the base station transmits at block 1104.

In some implementations, the method 1100 includes an additional block in which the base station transmits to the user device a message (e.g., event 910A) that indicates one or more cell selection offsets that are usable by the user device to determine suitability of the cell for cell selection. Alternatively, the cell selection offset(s) may be included in the first message that the base station transmits at block 1104.

In some implementations, the method 1100 includes an additional block in which the base station transmits to the user device a message (e.g., event 1010) that indicates one or more cell reselection offsets that are usable by the user device to determine ranks for one or more cells (including the cell associated with the base station implementing the method 1100) during cell reselection. Alternatively, the cell reselection offset(s) may be included in the first message that the base station transmits at block 1104. In either of these implementations, the method 1100 may include still another block in which the base station transmits to the user device another message indicating one or more neighboring cells that support at least one network slice also supported by the cell of the base station implementing the method 1100 (e.g., a “favored” cell list indicating the neighboring cells that support all of the same network slices). Alternatively, the indication of these neighboring cells may be included in the first message that the base station transmits at block 1104.

Referring next to FIG. 12, an example method 1200 can be implemented in a user device (e.g., UE 102) configured to communicate with a base station (e.g., base station 104A) when located in a coverage area of a cell associated with the base station (e.g., cell 124A). For example, the method 1200 may be implemented in whole or in part by processing hardware 140 of the UE 102.

At block 1202, the user device receives a first message from the base station (e.g., event 310, 910A, or 1010). At block 1204, the user device determines a set of one or more network slices supported by the cell associated with the base station by processing the first message received at block 1202. At block 1206, the user device determines, based at least in part on the set of supported network slices, whether to communicate data associated with a desired network slice via the cell (e.g., in a cell selection or cell reselection procedure).

In some implementations and/or scenarios, the method 1200 includes one or more additional blocks not shown in FIG. 12. For example, the method 1200 may include an additional block (prior to block 1206) in which the user device determines the desired network slice, e.g., by communicating an indicator of the desired network slice (e.g., within a list of desired slices) from a NAS layer to an AS layer implemented in the user device (e.g., from the NAS controller 144 to the AS controller 142).

In some implementations, the method 1200 includes additional blocks in which the user device transmits a request message to the base station (e.g., event 320, 420A, 420B, or 520), and in response receives from the base station a second message including information regarding network support for the desired network slice (e.g., event 330, 430A, 430B, or 530). The method 1200 may further include a block in which the user device performs a cell reselection procedure based on the information in the second message. In implementations where the request message transmitted by the user device is a first random access message (e.g., Msg1 or MsgA) and the response message transmitted by the base station is a second random access message (e.g., Msg2 or MsgB), the method 1200 may include yet another block in which the user device, before transmitting the first random access message, receives another message indicating one or more RACH configurations (including a slice-specific RACH configuration that the user device uses to generate and transmit the first random access message) from the base station.

In some implementations (e.g., if block 1206 includes performing cell selection), the method 1200 includes a first additional block (or set of blocks) in which the user device receives one or more other messages (e.g., event 910B and/or 910C) from one or more other respective base stations (e.g., base station 104B and/or 104C) associated with one or more other respective cells (e.g., cell 124B and/or 124C), and a second additional block (or set of blocks) in which, for each of the one or more other messages, the user device determines one or more other respective sets of network slices supported by the respective cell.

In some implementations (e.g., if block 1206 includes performing cell selection), the method 1200 includes an additional block in which the user device receives another message from the base station indicating one or more cell selection offsets (e.g., the offsets provided at event 910A). Alternatively, the first message that the user device receives at block 1202 may include the cell selection offsets.

In some implementations (e.g., if block 1206 includes performing cell reselection), the method 1200 includes an additional block in which the user device receives another message from the base station indicating one or more cell reselection offsets (e.g., the offsets provided at event 1010). Alternatively, the first message that the user device receives at block 1202 may include the cell reselection offsets. In either of these implementations, the method 1200 may include still another block in which the user device receives from the base station another message indicating one or more neighboring cells that support at least one network slice also supported by the serving cell (e.g., a “favored” cell list indicating the neighboring cells that support all of the same network slices). Alternatively, the indication of these neighboring cells may be included in the first message that the user device receives at block 1202.

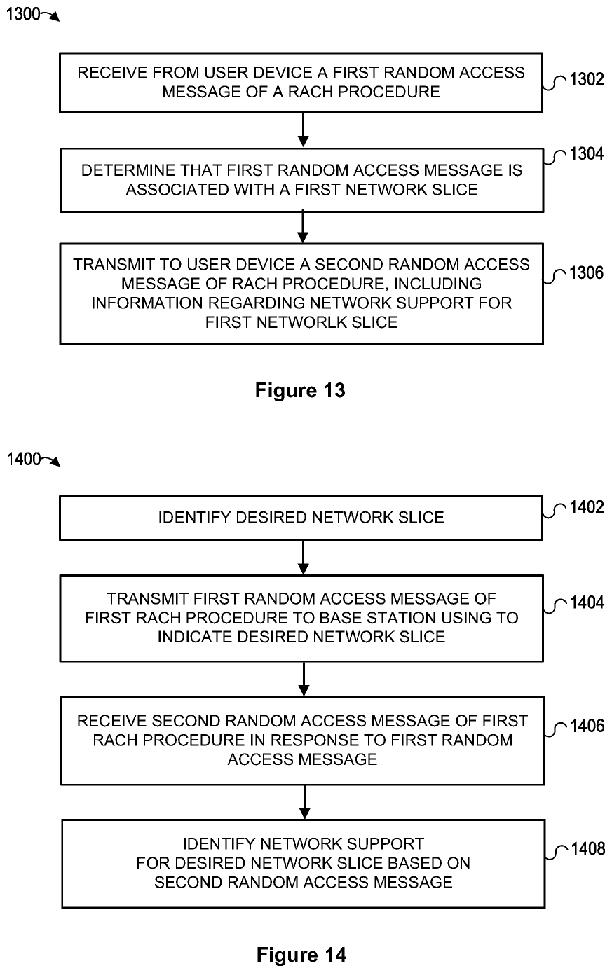

FIGS. 13 and 14 show example methods for using a RACH procedure to obtain network support information for a slice.

Referring first to FIG. 13, an example method 1300 can be implemented in a base station (e.g., base station 104A) configured to communicate with a user device (e.g., UE 102) located in a coverage area of a cell associated with the base station (e.g., cell 124A). For example, the method 1300 may be implemented in whole or in part by processing hardware 130 of base station 104A.

At block 1302, the base station receives a first random access message of a RACH procedure from the user device (e.g., event 320, 420A, 420B, or 520). At block 1304, the base station determines that the first random access message is associated with a first network slice (e.g., event 425A, 426B, or 526). At block 1306, the base station transmits to the user device a second random access message of the RACH procedure (e.g., event 330, 430A, 430B, or 530), which includes information regarding network support for the first network slice.

In some implementations and/or scenarios, the method 1300 includes one or more additional blocks not shown in FIG. 13. For example, the method 1300 may include an additional block (prior to block 1302) in which the base station transmits to the user device a configuration message that provides at least the slice-specific RACH configuration (e.g., preamble, PRACH occasion, etc.) that the user device uses to generate and transmit the first random access message. The method 1300 may also include blocks in which the base station transmits to the user device other slice-specific RACH configurations associated with other slices.

Referring next to FIG. 14, an example method 1400 can be implemented in a user device (e.g., UE 102) configured to communicate with a base station (e.g., base station 104A) when located in a coverage area of a cell associated with the base station (e.g., cell 124A). For example, the method 1200 may be implemented in whole or in part by processing hardware 140 of the UE 102.

At block 1402, the user device identifies a desired network slice (e.g., event 314). At block 1404, the user device transmits a first random access message of a first RACH procedure to the base station, to indicate the desired network slice to the base station (e.g., event 320, 420A, 420B, or 520). At block 1406, the user device receives a second random access message of the first RACH procedure in response to the first random access message (e.g., event 330, 430A, 430B, or 530). At block 1408, the user device identifies network support for the desired network slice based on the second random access message received at block 1406.

In some implementations and/or scenarios, the method 1400 includes one or more additional blocks not shown in FIG. 14. For example, the method 1400 may include an additional block (prior to block 1404) in which the user device receives from the base station (or a neighboring base station) a configuration message that configures the user device to use the first RACH configuration (e.g., preamble, PRACH occasion, etc.) for requesting information regarding network support for the desired network slice. The method 1400 may also, or instead, include an additional block, occurring after block 1408, in which the user device performs a cell reselection procedure based at least in part on the network support identified at block 1408 (e.g., to reselect to a cell that supports the desired network slice).

The following list of examples reflects a variety of the embodiments explicitly contemplated by the present disclosure:

Example 1. A method in a base station configured to communicate with a user device located in a coverage area of a cell associated with the base station, the method comprising: receiving from the user device a first random access message of a random access channel, RACH, procedure; determining, by processing hardware of the base station, that the first random access message is associated with a first network slice; and transmitting to the user device a second random access message of the RACH procedure, the second random access message including information regarding network support for the first network slice.

Example 2. The method of example 1, wherein the first network slice corresponds to a network slice selection assistance information (NSSAI) or a single NSSAI (S-NSSAI).

Example 3. The method of example 1 or 2, wherein the second random access message includes information indicating one or more of: a radio access technology, RAT, that supports the first network slice; a frequency that supports the first network slice; a physical cell identifier of a neighboring cell that supports the first network slice; a RACH configuration associated with the neighboring cell; or whether the neighboring cell supports a second network slice.

Example 4. The method of any one of examples 1 through 3, wherein determining that the first random access message is associated with the first network slice includes: determining that the user device transmitted the first random access message using a first RACH configuration associated with the first network slice.

Example 5. The method of example 4, wherein determining that the user device transmitted the first random access message using the first RACH configuration includes one or both of: determining that the first random access message includes a preamble associated with the first network slice; and determining that the user device transmitted the first random access message using a physical random access channel, PRACH, occasion associated with the first network slice.

Example 6. The method of example 5, further comprising: before receiving the first random access message, transmitting to the user device a configuration message that provides at least the first RACH configuration.

Example 7. The method of example 6, wherein the configuration message indicates one or more of: a preamble; a physical random access channel, PRACH, occasion; a maximum number of allowed preamble transmissions; a type of the RACH procedure; a window of time for receiving a RACH message from the base station; a contention resolution time; a power increment for successive preamble transmissions; or a back-off factor to be used by the user device when performing back-off in the RACH procedure.

Example 8. The method of example 7, wherein the configuration message indicates a CORESET and/or search space that the user device is to use to detect a channel carrying the second random access message.

Example 9. The method of any one of examples 6 through 8, further comprising: transmitting to the user device another configuration message that provides at least a second RACH configuration for requesting information regarding network support for a second network slice.

Example 10. The method of any one of examples 6 through 9, wherein transmitting the configuration message includes: broadcasting system information specifying at least a portion of the first RACH configuration; or transmitting a radio resource control, RRC, message specifying at least a portion of the first RACH configuration.

Example 11. The method of example 10, wherein transmitting the configuration message includes transmitting the RRC message during: an RRC reconfiguration procedure; an RRC establishment procedure; an RRC reestablishment procedure; or an RRC connection resume procedure.

Example 12. The method of any one of examples 1 through 11, wherein: the first random access message is a MsgA of a two-step contention-based RACH procedure; and the second random access message is a MsgB of the two-step contention-based RACH procedure.

Example 13. The method of any one of examples 1 through 11, wherein: the first random access message is a Msg3 of a four-step contention-based RACH procedure; determining that the first random access message is associated with the first network slice includes identifying an indicator of the first network slice in the Msg3; and the second random access message is a Msg4 of the four-step contention-based RACH procedure.

Example 14. The method of any one of examples 1 through 11, wherein: the first random access message is a Msg1 of a four-step contention-based RACH procedure; and the second random access message is a Msg2 of the four-step contention-based RACH procedure.

Example 15. A method in a user device configured to communicate with a base station when located in a coverage area of a cell associated with the base station, the method comprising: identifying, by processing hardware of the user device, a desired network slice; transmitting a first random access message of a first random access channel, RACH, procedure to the base station to indicate the desired network slice; receiving a second random access message of the first RACH procedure in response to the first random access message; and identifying, by the processing hardware and based on the second random access message, network support for the desired network slice.

Example 16. The method of example 15, wherein the desired network slice corresponds to a network slice selection assistance information (NSSAI) or a single NSSAI (S-NSSAI).

Example 17. The method of example 15 or 16, wherein transmitting the first random access message includes one or both of: transmitting a preamble associated with the desired network slice; and transmitting the first random access message using a physical random access channel, PRACH, occasion associated with the desired network slice.

Example 18. The method of any one of examples 15 through 17, wherein the second random access message includes information indicating one or more of: a radio access technology, RAT, that supports the desired network slice; a frequency that supports the desired network slice; a physical cell identifier of a neighboring cell that supports the desired network slice; a RACH configuration associated with the neighboring cell; or whether the neighboring cell supports another network slice.

Example 19. The method of any one of examples 15 through 18, wherein: transmitting the first random access message to the base station includes transmitting the first random access message using a first RACH configuration associated with the desired network slice; and the method further comprises, before transmitting the first random access message, receiving from the base station or a neighbor base station a configuration message that configures the user device to use the first RACH configuration for requesting information regarding network support for the desired network slice.

Example 20. The method of example 19, wherein the configuration message indicates one or more of: a preamble; a physical random access channel, PRACH, occasion; a maximum number of allowed preamble transmissions; a type of the first RACH procedure; a window of time for receiving a RACH message from the base station; a contention resolution time; a power increment for successive preamble transmissions; or a back-off factor to be used by the user device when performing back-off in the first RACH procedure.

Example 21. The method of example 19 or 20, wherein: the configuration message indicates a CORSET and/or search space; and receiving the second random access message includes using the CORESET and/or search space to detect a channel carrying the second random access message.

Example 22. The method of any one of examples 19 through 21, wherein receiving the configuration message includes: receiving system information that was broadcast by the base station and specifies at least a portion of the first RACH configuration; or receiving a radio resource control, RRC, message specifying at least a portion of the first RACH configuration.

Example 23. The method of example 22, wherein receiving the configuration message includes receiving the RRC message during: an RRC reconfiguration procedure; an RRC establishment procedure; an RRC reestablishment procedure; or an RRC connection resume procedure.

Example 24. The method of any one of examples 15 through 23, further comprising: after identifying the network support for the desired network slice, performing, by the processing hardware, a cell reselection procedure based at least in part on the identified network support.

Example 25. The method of any one of examples 15 through 24, wherein: the first random access message is a MsgA of a two-step contention-based RACH procedure; and the second random access message is a MsgB of the two-step contention-based RACH procedure.

Example 26. The method of any one of examples 15 through 24, wherein: the first random access message is a Msg3 of a four-step contention-based RACH procedure, the Msg3 including an indication of the desired network slice; and the second random access message is a Msg4 of the four-step contention-based RACH procedure.

Example 27. The method of any one of examples 15 through 24, wherein: the first random access message is a Msg1 of a four-step contention-based RACH procedure; and the second random access message is a Msg2 of the four-step contention-based RACH procedure.

Example 28. The method of any one of examples 15 through 27, wherein identifying the desired network slice includes communicating an indicator of the desired network slice from a non-access stratum, NAS, layer to an access stratum, AS, layer.

Example 29. The method of any one of examples 15 through 28, wherein identifying the desired network slice includes determining that the user device has first data associated with the desired network slice ready for uplink transmission.

Example 30. A base station comprising hardware and configured to implement the method of any one of examples 1 through 14.

Example 31. A user device comprising hardware and configured to implement the method of any one of examples 15 through 29.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for providing RAN support of network slicing through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method of wireless communication at a base station, the method comprising:
generating, by the base station, first message collectively indicating a set of one or more network slices supported by a cell of the base station and a set of priorities usable by a user equipment (UE) when performing cell selection, the set of priorities defining priorities for a plurality of frequencies; and
transmitting the first message to the UE.

2. The method of claim 1, wherein the transmitting of the first message includes a dedicated radio resource control, RRC, message.

3. The method of claim 2, further comprising:
receiving a request message from the UE; and
in response to the request message, transmitting to the UE a second message including information regarding network support for one or more network slices.

4. The method claim 1, wherein:
the first message collectively indicate one or more neighboring cells that support at least one network slice of the set of network slices; or
the first message collectively indicate that the one or more neighboring cells support a plurality of network slices in the set of network slices.

5. The method of claim 1, further comprising:
transmitting, to the UE, an additional message indicating the set of priorities.

6. The method of claim 5, wherein the first message or the additional message includes an area-specific tag value that indicates the set of priorities.

7. The method of claim 6, and wherein the area-specific tag value is a particular a tracking area code, TAC, a radio access network, (RAN), area code, a list of cells, or (iv) local area data network, LADN, information.

8. The method of claim 5, wherein the first message or the additional message include a set of indices that indicates the set of priorities.

9. The method of claim 1, wherein the set of priorities is specific to at least one network slice of the set of network slices supported by the cell.

10. A method of wireless communication at a user equipment (UE), the method comprising:
receiving, from a base station, the first message;
processing, the first message collectively indicating a set of one or more network slices supported by a cell and a set of priorities for a plurality of frequencies
applying, by the UE, the set of frequency priorities, the set of priorities being specific to at least one network slice of a set of network slices supported by the cell; and
performing by the UE, a cell selection procedure using at least one of the set of priorities.

11. The method of claim 10, wherein receiving of the first message includes a dedicated radio resource control, RRC, message.

12. The method of claim 11, further comprising:
transmitting, to the base station, a request message; and
receiving, from the base station, a second message including information regarding network support fro one or more network slices.

13. The method of claim 10, wherein:
the first message collectively indicate one or more neighboring cells that support the at least one network slice of the set of network slices, or
the first message collectively indicate that the one or more neighboring cells supports a plurality of network slices in the set of network slices.

14. The method of claim 13, further comprising,
receiving from the base station, an additional message indicating the set of priorities.

15. The method of claim 14, wherein the first message or the additional message include an area-specific tag value that indicates the set of priorities.

16. The method of claim 15, and wherein the area-specific tag value is a particular a tracking area code (TAC), a radio access network (RAN), area code, a list of cells, or local area data network (LADN) information

17. The method of claim 14, wherein the first message or the additional message include a set of indices that indicates the set of priorities.

18. The method of claim 17, wherein the set of priorities is specific to at least one network slice of the set of network slices supported by the cell.

19. A network entity comprising:
at least on processor, and
computer-readable storage media comprising instructions that, responsive to execution by the at least one processor, direct the network entity to perform a method for communication with a user equipment (UE) located in a coverage area of a cell associated with a base station, the method comprising:
generating, by the base station, the first message collectively indicating a set of one or more network slices supported by the cell and a set of priorities usable by the UE when performing cell selection, the set of priorities defining priorities for a plurality of frequencies; and
transmitting the first message to the UE.

20. The network entity of claim 19, wherein the transmitting of the first message includes a dedicated radio resource control, RRC message.
